(19) United States
(12) Patent Application Publication
(10) Pub. No.: US 2025/0330929 A1
(43) Pub. Date: Oct. 23, 2025

(54) METHOD AND APPARATUS FOR GENERATING PRIMARY SYNCHRONIZATION SIGNAL IN WIRELESS COMMUNICATION SYSTEM

(71) Applicant: ELECTRONICS AND TELECOMMUNICATIONS RESEARCH INSTITUTE, Daejeon (KR)

(72) Inventors: Byung-Jae KWAK, Daejeon (KR); Jin Kyeong KIM, Daejeon (KR); Woncheol CHO, Daejeon (KR); Young Jo KO, Daejeon (KR); Heesoo LEE, Daejeon (KR); Jung Ho MYUNG, Daejeon (KR); Chanho YOON, Daejeon (KR)

(73) Assignee: ELECTRONICS AND TELECOMMUNICATIONS RESEARCH INSTITUTE, Daejeon (KR)

(21) Appl. No.: 19/184,940

(22) Filed: Apr. 21, 2025

(30) Foreign Application Priority Data
Apr. 19, 2024 (KR) 10-2024-0052982
Aug. 29, 2024 (KR) 10-2024-0117204
Jan. 24, 2025 (KR) 10-2025-0011060

(51) Int. Cl. H04W 56/00; H04J 11/00

(52) U.S. Cl. CPC H04W 56/0015; H04J 11/0073

(57) ABSTRACT

A method of a user equipment (UE) according to an exemplary embodiment of the present disclosure may comprise: calculating first coefficients based on a combination of an i-th primary synchronization signal (PSS) sequence and an auxiliary sequence; receiving a j-th PSS sequence from a base station; and determining whether the received j-th PSS sequence corresponds to the i-th PSS sequence based on a correlation between the j-th PSS sequence and the first coefficients, wherein each of i and j is a natural number indicating an index of one of possible PSS sequences, and the auxiliary sequence is orthogonal to the i-th PSS sequence.

### CROSS-REFERENCE TO RELATED APPLICATIONS

This application claims priority to Korean Patent Applications No. 10-2024-0052982, filed on Apr. 19, 2024; No. 10-2024-0117204, filed on Aug. 29, 2024; and No. 10-2025-0011060, filed on Jan. 24, 2025, with the Korean Intellectual Property Office (KIPO), the entire contents of which are hereby incorporated by reference.

### BACKGROUND

### 1. Technical Field

The present disclosure relates to a synchronization signal generation technique in a wireless communication system, and more particularly, to a technique for generating a primary synchronization signal in a wireless communication system.

### 2. Related Art

Wireless communication systems have been developed to enable communication between remote terminals, and with the advent of mobile communication systems, anyone with a mobile terminal can communicate in most parts of the world. A representative standardization body for such mobile communication systems is the 3rd Generation Partnership Project (3GPP). The 3GPP has been undertaking standardization efforts for Long Term Evolution (LTE), LTE-Advanced (LTE-A), and New Radio (NR). The NR wireless communication protocol is also referred to as the 5th Generation (5G) wireless communication protocol.

In a wireless communication system, an important procedure in an initial operation of a terminal may be a procedure of detecting a synchronization signal transmitted by a base station. By acquiring the synchronization signal transmitted by the base station, the terminal can acquire downlink synchronization from the base station. Base stations in the 3GPP wireless communication systems, such as LTE-A systems and NR systems, can transmit a primary synchronization signal (PSS) and a secondary synchronization signal (SSS) to the terminal. The PSS sequences used in the LTE-A system and the NR system are composed of different sequences.

Meanwhile, discussions on the sixth generation (6G) wireless communication system, which follows 5G NR, are expected to begin within the 3GPP. In 6G as well, a procedure of detecting a signal transmitted by a base station during an initial operation of a terminal to acquire downlink synchronization may be a very important procedure. Furthermore, it is expected that frequency bands higher than those used in the LTE-A and NR systems will be employed in the 6G wireless communication system. Accordingly, synchronization signals that satisfy system requirements specified for 6G are needed.

### SUMMARY

The present disclosure for resolving the above-described problems is directed to providing a method and apparatus for generating synchronization signals to be used in a next generation wireless communication system.

A method of a user equipment (UE), according to an exemplary embodiment of the present disclosure, may comprise: calculating first coefficients based on a combination of an i-th primary synchronization signal (PSS) sequence and an auxiliary sequence; receiving a j-th PSS sequence from a base station; and determining whether the received j-th PSS sequence corresponds to the i-th PSS sequence based on a correlation between the j-th PSS sequence and the first coefficients, wherein each of i and j is a natural number indicating an index of one of possible PSS sequences, and the auxiliary sequence is orthogonal to the i-th PSS sequence.

The auxiliary sequence may be determined based on a sum of a first objective function related to autocorrelation sidelobes of the i-th PSS sequence and a second objective function related to cross-correlation between the i-th PSS sequence and one of sequences other than the i-th PSS sequence.

Each of the first objective function and the second objective function may include a first element for providing a penalty for cases where a cost increases in the auxiliary sequence.

When a value of the first element is greater than 1, each of the first objective function and the second objective function may be calculated through iterative operations, and each of the first objective function and the second objective function may be iteratively calculated by a projected gradient descent (PGD) scheme during the iterative operations.

The iterative operations by the PGD scheme may be performed through iterations of first and second steps, the first step may be a step of performing a gradient descent update without constraints, and the second step may be a step of reprojecting the auxiliary sequence moved out of a constraint space by the gradient descent update to a nearest point within the constraint space.

The first objective function may be calculated by excluding sidelobes and peaks for autocorrelation within a range of an exclusion radius determined by experiments.

A user equipment (UE), according to an exemplary embodiment of the present disclosure, may comprise: at least one processor, wherein the at least one processor may cause the UE to perform: calculating first coefficients based on a combination of an i-th primary synchronization signal (PSS) sequence and an auxiliary sequence; receiving a j-th PSS sequence from a base station; and determining whether the received j-th PSS sequence corresponds to the i-th PSS sequence based on a correlation between the j-th PSS sequence and the first coefficients, wherein each of i and j is a natural number indicating an index of one of possible PSS sequences, and the auxiliary sequence is orthogonal to the i-th PSS sequence.

The auxiliary sequence may be determined based on a sum of a first objective function related to autocorrelation sidelobes of the i-th PSS sequence and a second objective function related to cross-correlation between the i-th PSS sequence and one of sequences other than the i-th PSS sequence.

Each of the first objective function and the second objective function may include a first element for providing a penalty for cases where a cost increases in the auxiliary sequence.

When a value of the first element is greater than 1, each of the first objective function and the second objective function may be calculated through iterative operations, and each of the first objective function and the second objective function may be iteratively calculated by a projected gradient descent (PGD) scheme during the iterative operations.

The at least one processor may further cause the UE to perform: performing the iterative operations by the PGD scheme through iterations of first and second steps, wherein the first step may be a step of performing a gradient descent update without constraints, and the second step may be a step of reprojecting the auxiliary sequence moved out of a constraint space by the gradient descent update to a nearest point within the constraint space.

The first objective function may be calculated by excluding sidelobes and peaks for autocorrelation within a range of an exclusion radius determined by experiments.

A method of designing a primary synchronization signal, according to an exemplary embodiment of the present disclosure, may comprise: collecting requirements of a target system for which the PSS is to be transmitted; determining a first cost function based on the requirements; obtaining a first PSS sequence that minimizes the first cost function using a gradient descent algorithm; testing whether the obtained first PSS sequence satisfies a preconfigured condition; and in response to the obtained first PSS sequence satisfying the preconfigured condition, determining the obtained first PSS sequence as a final PSS sequence.

The requirements may include at least one of a first characteristic minimizing a sidelobe level in aperiodic autocorrelation, a second characteristic minimizing an aperiodic cross-correlation level between different sequences, or a third characteristic having a spectral flatness value within a preset spectral flatness value.

The cost function may be determined based on a combination of a first function for aperiodic autocorrelation and a second function for periodic autocorrelation based on a set of complex frequency domain sequences converted to a time domain based on the first characteristic and the second characteristic.

The third characteristic may correspond to a case where a modulus-1 constraint is applied to restrict absolute values of all elements of a sequence to 1 in frequency domain.

The method may further comprise: updating the gradient descent algorithm based on the third characteristic.

The updating of the gradient descent algorithm may comprise: generating a first intermediate sequence that deviates from the modulus-1 constraint, based on the obtained first PSS sequence; and generating a second intermediate sequence by normalizing the first intermediate sequence to restore the modulus-1 constraint.

The method may further comprise: in response to the obtained first PSS sequence not satisfying the preconfigured condition, determining whether to redefine the first cost function; in response to determining to redefine the first cost function, defining a second cost function based on the requirements; and obtaining a second PSS sequence that minimizes the second cost function using a gradient descent algorithm.

The method may further comprise: in response to the obtained first PSS sequence not satisfying the preconfigured condition, determining whether to redefine the first cost function; and in response to determining not to redefine the first cost function, obtaining a second PSS sequence that minimizes the first cost function.

According to the exemplary embodiments of the present disclosure, a PSS sequence can be configured to reduce false detections caused by irregular spikes at a terminal. In particular, by defining a cost function and incorporating additional constraints therein during the design process, it is possible to generate a PSS sequence with enhanced characteristics, such as increased tolerance to frequency offsets. Additionally, the PSS sequence design method described herein may facilitate the generation of sequences having arbitrary lengths. Furthermore, the method is not limited to synchronization sequence design and may be extended to the design of any sequence subject to clearly defined requirements.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a computer for designing a PSS sequence.

FIG. 4 is a flowchart illustrating a traditional PSS sequence design method.

FIG. 5 is a flowchart illustrating a PSS sequence design method according to an exemplary embodiment of the present disclosure.

FIG. 6 is a graph illustrating a loss curve obtained through an optimization process using the gradient descent algorithm.

FIG. 7A is a graph of an aperiodic correlation (autocorrelation) function between the zeroth PSS and the zeroth PSS among the 5G NR PSS sequences.

FIG. 7B is a graph of an aperiodic correlation (cross-correlation) function between the zeroth PSS and the first PSS.

FIG. 7C is a graph of an aperiodic correlation (cross-correlation) function between the zeroth PSS and the second PSS.

FIG. 7D is a graph of an aperiodic correlation (cross-correlation) function between the first PSS and the zeroth PSS.

FIG. 7E is a graph of an aperiodic correlation (autocorrelation) function between the first PSS and the first PSS.

FIG. 7F is a graph of an aperiodic correlation (cross-correlation) function between the first PSS and the second PSS.

FIG. 7G is a graph of an aperiodic correlation (cross-correlation) function between the second PSS and the zeroth PSS.

FIG. 7H is a graph of an aperiodic correlation (cross-correlation) function between the second PSS and the first PSS.

FIG. 7I is a graph of an aperiodic correlation (cross-correlation) function between the first PSS and the second PSS.

FIG. 8A is a graph of an aperiodic correlation (autocorrelation) function between the zeroth random phase signal and the zeroth random phase signal among the random phase PSS sequences.

FIG. 8B is a graph of an aperiodic correlation (cross-correlation) function between the zeroth random phase signal and the first random phase signal.

FIG. 8C is a graph of an aperiodic correlation (cross-correlation) function between the zeroth random phase signal and the second random phase signal.

FIG. 8D is a graph of an aperiodic correlation (cross-correlation) function between the first random phase signal and the zeroth random phase signal.

FIG. 8E is a graph of an aperiodic correlation (autocorrelation) function between the first random phase signal and the first random phase signal.

FIG. 8F is a graph of an aperiodic correlation (cross-correlation) function between the first random phase signal and the second random phase signal.

FIG. 8G is a graph of an aperiodic correlation (cross-correlation) function between the second random phase signal and the zeroth random phase signal.

FIG. 8H is a graph of an aperiodic correlation (cross-correlation) function between the second random phase signal and the first random phase signal.

FIG. 8I is a graph of an aperiodic correlation (cross-correlation) function between the second random phase signal and the second random phase signal.

FIG. 9A is a graph of an aperiodic correlation (cross-correlation) function between the zeroth optimized PSS and the zeroth optimized PSS.

FIG. 9B is a graph of an aperiodic correlation (cross-correlation) function between the zeroth optimized PSS and the first optimized PSS.

FIG. 9C is a graph of an aperiodic correlation (cross-correlation) function between the zeroth optimized PSS and the second optimized PSS.

FIG. 9D is a graph of an aperiodic correlation (cross-correlation) function between the first optimized PSS and the zeroth optimized PSS.

FIG. 9E is a graph of an aperiodic correlation (cross-correlation) function between the first optimized PSS and the first optimized PSS.

FIG. 9F is a graph of an aperiodic correlation (cross-correlation) function between the first optimized PSS and the second optimized PSS.

FIG. 9G is a graph of an aperiodic correlation (cross-correlation) function between the second optimized PSS and the zeroth optimized PSS.

FIG. 9H is a graph of an aperiodic correlation (cross-correlation) function between the second optimized PSS and the first optimized PSS.

FIG. 9I is a graph of an aperiodic correlation (cross-correlation) function between the second optimized PSS and the second optimized PSS.

FIG. 10 is a conceptual diagram illustrating an apparatus for detecting a 5G NR PSS sequence according to the present disclosure.

FIG. 11 is a conceptual diagram illustrating a structure of an SSB transmitted by a base station based on the 5G NR technical specifications.

FIG. 12 is another conceptual diagram illustrating an apparatus for detecting a 5G NR PSS sequence according to the present disclosure.

FIG. 13 is a graph illustrating an eigenvalue spectrum of R₀.

FIG. 14A is a simulation graph of r₀₀[n] of a conventional correlator.

FIG. 14B is a graph illustrating a peak area near n=0 for the same signal in further detail.

FIG. 15A is a simulation graph of r₀₀[n] for a PSS detector according to the present disclosure with exclusion radius r=0 and q=4.

FIG. 15B is a graph of a correlation function between s₀[n] and the auxiliary signal a₀[n] under the same conditions.

FIG. 16 is a histogram illustrating sidelobe magnitudes of autocorrelation and magnitudes of cross-correlation.

FIG. 17A is a graph of an aperiodic correlation (autocorrelation) function between the zeroth PSS and the zeroth PSS among 5G NR PSS sequences in a correlator of a 5G NR terminal.

FIG. 17B is a graph of an aperiodic correlation (cross-correlation) function between the zeroth PSS and the first PSS among 5G NR PSS sequences in a correlator of a 5G NR terminal.

FIG. 17C is a graph of an aperiodic correlation (cross-correlation) function between the zeroth PSS and the second PSS among 5G NR PSS sequences in a correlator of a 5G NR terminal.

FIG. 17D is a graph of an aperiodic correlation (cross-correlation) function between the first PSS and the zeroth PSS among 5G NR PSS sequences in a correlator of a 5G NR terminal.

FIG. 17E is a graph of an aperiodic correlation (cross-correlation) function between the first PSS and the first PSS among 5G NR PSS sequences in a correlator of a 5G NR terminal.

FIG. 17F is a graph of an aperiodic correlation (cross-correlation) function between the first PSS and the second PSS among 5G NR PSS sequences in a correlator of a 5G NR terminal.

FIG. 17G is a graph of an aperiodic correlation (cross-correlation) function between the second PSS and the zeroth PSS among 5G NR PSS sequences in a correlator of a 5G NR terminal.

FIG. 17H is a graph of an aperiodic correlation (cross-correlation) function between the second PSS and the first PSS among 5G NR PSS sequences in a correlator of a 5G NR terminal.

FIG. 17I is a graph of an aperiodic correlation (cross-correlation) function between the first PSS and the second PSS among 5G NR PSS sequences in a correlator of a 5G NR terminal.

FIG. 18A is a graph of an aperiodic correlation (cross-correlation) function between the zeroth PSS and the zeroth PSS among optimized PSS sequences when q=1 and r=3 in a correlator of a terminal using an auxiliary sequence.

FIG. 18B is a graph of an aperiodic correlation (cross-correlation) function between the zeroth PSS and the first PSS among optimized PSS sequences when q=1 and r=3 in a correlator of a terminal using an auxiliary sequence.

FIG. 18C is a graph of an aperiodic correlation (cross-correlation) function between the zeroth PSS and the second PSS among optimized PSS sequences when q=1 and r=3 in a correlator of a terminal using an auxiliary sequence.

FIG. 18D is a graph of an aperiodic correlation (cross-correlation) function between the first PSS and the zeroth PSS among optimized PSS sequences when q=1 and r=3 in a correlator of a terminal using an auxiliary sequence.

FIG. 18E is a graph of an aperiodic correlation (cross-correlation) function between the first PSS and the first PSS among optimized PSS sequences when q=1 and r=3 in a correlator of a terminal using an auxiliary sequence.

FIG. 18F is a graph of an aperiodic correlation (cross-correlation) function between the first PSS and the second PSS among optimized PSS sequences when q=1 and r=3 in a correlator of a terminal using an auxiliary sequence.

FIG. 18G is a graph of an aperiodic correlation (cross-correlation) function between the second PSS and the zeroth PSS among optimized PSS sequences when q=1 and r=3 in a correlator of a terminal using an auxiliary sequence.

FIG. 18H is a graph of an aperiodic correlation (cross-correlation) function between the second PSS and the first PSS among optimized PSS sequences when q=1 and r=3 in a correlator of a terminal using an auxiliary sequence.

FIG. 18I is a graph of an aperiodic correlation (cross-correlation) function between the second PSS and the second PSS among optimized PSS sequences when q=1 and r=3 in a correlator of a terminal using an auxiliary sequence.

FIG. 19A is a graph of an aperiodic correlation (cross-correlation) function between the zeroth PSS and the zeroth PSS among optimized PSS sequences when q=4 and r=3 in a correlator of a terminal using an auxiliary sequence.

FIG. 19B is a graph of an aperiodic correlation (cross-correlation) function between the zeroth PSS and the first PSS among optimized PSS sequences when q=4 and r=3 in a correlator of a terminal using an auxiliary sequence.

FIG. 19C is a graph of an aperiodic correlation (cross-correlation) function between the zeroth PSS and the second PSS among optimized PSS sequences when q=4 and r=3 in a correlator of a terminal using an auxiliary sequence.

FIG. 19D is a graph of an aperiodic correlation (cross-correlation) function between the first PSS and the zeroth PSS among optimized PSS sequences when q=4 and r=3 in a correlator of a terminal using an auxiliary sequence.

FIG. 19E is a graph of an aperiodic correlation (cross-correlation) function between the first PSS and the first PSS among optimized PSS sequences when q=4 and r=3 in a correlator of a terminal using an auxiliary sequence.

FIG. 19F is a graph of an aperiodic correlation (cross-correlation) function between the first PSS and the second PSS among optimized PSS sequences when q=4 and r=3 in a correlator of a terminal using an auxiliary sequence.

FIG. 19G is a graph of an aperiodic correlation (cross-correlation) function between the second PSS and the zeroth PSS among optimized PSS sequences when q=4 and r=3 in a correlator of a terminal using an auxiliary sequence.

FIG. 19H is a graph of an aperiodic correlation (cross-correlation) function between the second PSS and the first PSS among optimized PSS sequences when q=4 and r=3 in a correlator of a terminal using an auxiliary sequence.

FIG. 19I is a graph of an aperiodic correlation (cross-correlation) function between the second PSS and the second PSS among optimized PSS sequences when q=4 and r=3 in a correlator of a terminal using an auxiliary sequence.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

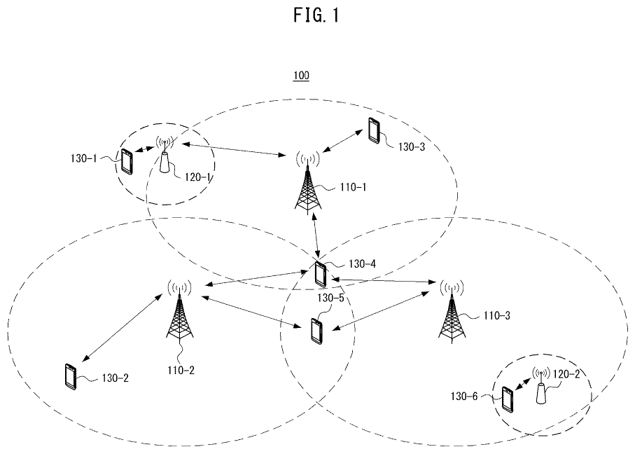

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

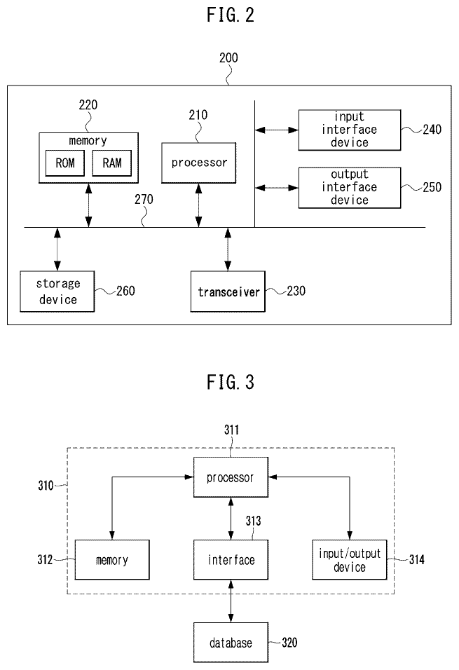

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Hereinafter, synchronization signals transmitted from a base station to a terminal are described. The synchronization signals may be classified into a primary synchronization signal (PSS) and a secondary synchronization signal (SSS), as described above. A base station in a 5G NR system may transmit a synchronization signal block (SSB) that can be used by the terminal for initial synchronization and/or cell search. The SSB in the 5G NR system may always be transmitted together with a physical broadcast channel (PBCH).

A representative case in which the terminal receives SSBs in the 5G NR system may be when the terminal performs initial synchronization. The initial synchronization may be a procedure in which the terminal searches for a base station (or cell) and acquires downlink synchronization from the base station (or cell) when power is turned on.

An SSB may also be used when the terminal loses synchronization and re-searches for a cell, in which case the terminal may perform a procedure for acquiring downlink synchronization from a base station (or cell) by searching for the SSB similarly to the initial synchronization procedure.

Another case in which the terminal receives SSBs may be when the terminal performs a handover. When the terminal moves from a serving base station to one of neighboring base stations as a target base station, the UE may perform a procedure for acquiring downlink synchronization from the target base station (or cell) by searching for the target base station (or cell).

Still another case in which the terminal receives SSBs may be when beamforming is performed and/or when measurement values are reported to the base station. When the terminal needs to perform measurement of reference signal received power (RSRP) or reference signal received quality (RSRQ) of SSBs received from the base station and needs to report measurement results to the base station, the terminal may receive the SSBs.

Since the terminal is required to measure SSBs in various cases as described above, the base station may periodically transmit SSBs. As described above, an SSB may include a PSS and an SSS. Among the PSS and the SSS, the terminal may search for the PSS first. When one of PSS sequences is detected, the terminal may acquire system timing information based on the PSS. Therefore, the PSS may serve as a fundamental signal for obtaining the system timing information. The terminal may obtain a cell (or base station) identification (ID) by combining the PSS sequence and an SSS sequence transmitted through the SSB.

As described above, the most important signal for initial synchronization between the terminal and the base station may be the PSS. Therefore, the PSS needs to be designed such that the terminal can search for the PSS despite uncertainty of a mobile communication channel. Hereinafter, a traditional PSS sequence design method is described.

FIG. 3 is a conceptual diagram illustrating a computer for designing a PSS sequence.

Referring to FIG. 3, a computer 310 may include a processor 311, a memory 312, an interface 313, and an input/output device 314. The processor 311 may control for the design of PSS sequences. The operation of the processor 311 is described in more detail through flowcharts below.

The memory 312 may be a storage for storing various programs for operating the computer 310. The memory 312 may include one or more of a ROM, a RAM, a hard disk, and an optical disk.

The interface 313 may provide an interface for connection with an external database 320. When the external database 320 is required to be connected through the Internet, the interface 313 may provide an interface for Internet access. When the external database 320 is connected through a local area communication network and/or a cable communication network, the interface 313 may provide a local area communication network interface and/or a cable communication network interface.

The input/output device 314 may provide an interface with a user of the computer, for example, a researcher who intends to design or develop a wireless communication system. The input/output device 314 may provide data input by the researcher to the processor 311. In addition, the input/output device 314 may provide visual and/or auditory information regarding step-by-step progress for generating the PSS or requesting input from the researcher.

The database 320 may be a memory storing various information of the communication system. The various information of the communication system may include requirements of the wireless communication system to be described below. When specific information is requested from the computer 310, the database 320 may retrieve and provide the corresponding information to the computer 310.

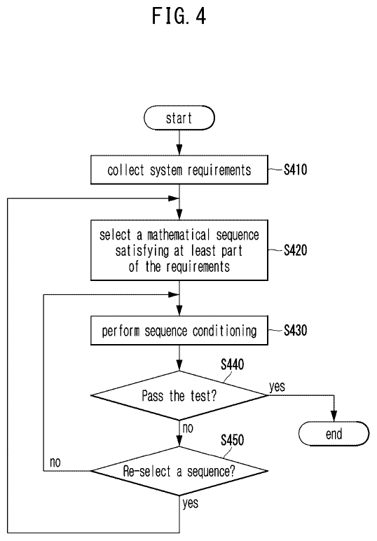

FIG. 4 is a flowchart illustrating a traditional PSS sequence design method.

Before referring to FIG. 4, it should be noted that all or some of the procedures illustrated in FIG. 4 may be executed by a computer and/or a specific program, for example, artificial intelligence (AI). However, certain procedures may be performed by a developer inputting data.

In step S410, the processor 311 of the computer may collect requirements of a wireless communication system to be developed. The requirements of the wireless communication system may be determined based on a frequency band to be used and characteristics of services to be provided. Accordingly, the system requirements may include various pieces of information. The requirements of the wireless communication system may be directly input by the developer of the wireless communication system and/or acquired from the database 320. The system requirements may include, for example, the following information.

First, information on a frequency band of the system in which a PSS sequence is to be used may be included. Depending on the frequency band used in the system, a Doppler shift, Doppler spread, average delay, delay spread, and carrier frequency offset (CFO) may be determined.

Second, information on characteristics of main services intended to be provided in the system in which the PSS sequence is to be used may be included. For example, in case of the 5G NR system, the system may be designed to provide enhanced mobile broadband (eMBB), ultra-reliable low latency communications (URLLC), and massive machine-type communications (mMTC). Depending on the required service characteristics, requirements for a terminal and/or requirements for the services may be determined. Therefore, the information on the characteristics of the main services may be required for designing the PSS to satisfy such requirements. The information on the characteristics of the main services may include information on mobility and/or movement speed of the terminal.

Third, requirements regarding a wireless channel environment in which the system using the PSS sequence is used may be included. The wireless channel environment may include a frequency-selective fading effect of a channel over which the PSS is transmitted, and a peak-to-average power ratio (PAPR) required by the system.

The above examples of system requirements are provided for convenience of understanding, and the system requirements are not limited to the contents exemplified above. In addition, some of the above-described requirements may not be considered in the design of the PSS, and other requirements not exemplified above may be considered in the design of the PSS.

In step S420, the processor 311 of the computer 310 may select mathematical sequences that satisfy at least some of the system requirements collected in step S410. In this case, some of the system requirements may be prioritized, and mathematical sequences satisfying the prioritized requirements may be sequentially listed according to the assigned priorities. This step may include selecting one sequence from the listed mathematical sequences.

As another method, the computer 310 may provide the mathematical sequences satisfying some of the collected requirements to the researcher through the input/output device 314, and one of the mathematical sequences may be selected according to the selection by the researcher.

There may exist a considerable number of mathematical sequences. However, in the current 3GPP technical specifications, widely known m-sequences and Zadoff-Chu sequences are used. More specifically, in the 3GPP LTE-A system, Zadoff-Chu sequences are used for the PSS, and in the 3GPP 5G NR system, an m-sequence is used for the PSS. Among the various mathematical sequences, there may exist several sequences that satisfy some of the system requirements, and the computer may select one sequence from among the several sequences.

In step S430, the computer may perform sequence conditioning on the selected mathematical sequence. In general, mathematical sequences are not designed for synchronization purposes in a wireless communication system. Although a mathematical sequence may have useful properties as a synchronization sequence, the mathematical sequence may generally lack characteristics required for a high-performance synchronization sequence. Furthermore, a mathematical sequence may have a problem of lacking flexibility.

For example, in the case of the Zadoff-Chu sequence mentioned above, some of useful properties may be lost if the length of the sequence is not a prime number. In the case of the m-sequence mentioned above, the length is always given as ‘2m−1’ for an integer m. In order to solve such problems, it is necessary to extend or puncture the mathematical sequence to adjust the length of the sequence.

Accordingly, the sequence conditioning may be a procedure that performs at least one of sequence extension, sequence puncturing, symbol mapping, normalization, or windowing on the mathematical sequence. The sequence extension may mean, for example, zero padding. The sequence extension may be required when the length of the selected mathematical sequence is not sufficiently long for use in the newly developed system or to perform a transformation for further satisfying desired properties and requirements.

The sequence puncturing may be a procedure of removing a part of the selected mathematical sequence or a newly generated sequence through sequence extension. This procedure may also be performed when the length of the selected mathematical sequence is longer than the sequence length required in the newly developed system or to perform a transformation for further satisfying desired properties and requirements.

The symbol mapping, normalization, or windowing may also be part of the transformation to further satisfy the requirements of the newly developed system.

In step S440, the computer may test the generated synchronization sequence, that is, the PSS. The testing of the PSS may be a procedure for verifying how well the generated PSS satisfies the requirements of the newly developed system. When the test of step S440 is passed, the procedure of FIG. 4 may be completed, and the new PSS sequence may be obtained.

If the test in step S440 fails to satisfy the requirements considered in the PSS design—in other words, if the test is not passed—the computer may determine in step S450 whether another sequence among the listed mathematical sequences needs to be selected. If another mathematical sequence needs to be selected, the procedure for PSS design may be performed again starting from step S420. If another mathematical sequence does not need to be selected (i.e. if the currently selected mathematical sequence is usable), the developer may perform the sequence conditioning of step S430 again.

Although the procedure of FIG. 4 has been described assuming that the procedure is performed by the computer, the procedure may also be performed directly by the developer. In addition, the computer 310 may perform the procedure directly or through a specialized program, for example, artificial intelligence (AI).

Hereinafter, a new approach for designing a PSS sequence according to the present disclosure is described. The approach for PSS design according to the present disclosure may acquire a PSS sequence by minimizing a cost function that encapsulates the requirements and specific properties that the PSS sequence needs to satisfy.

### [Prerequisites]

Before describing the new approach for PSS sequence design according to the present disclosure, prerequisites are described.

### A. Aperiodic Correlation and Periodic Correlation

Two different sequences of length N may be assumed as Equations 1 and 2 below.

$$\{ x [ n ] \vert n = 0 , 1 , … , N - 1 \} \qquad [ Equation 1 ]$$

$$\{ y [ n ] \vert n = 0 , 1 , … , N - 1 \} \qquad [ Equation 2 ]$$

In Equations 1 and 2, when n is less than zero or equal to or greater than N, a condition in Equation 3 is satisfied.

$$\begin{matrix}x [ n ] = y [ n ] = 0 , & for n < 0 , or n \geq N\end{matrix} \qquad [ Equation 3 ]$$

A cross-correlation between a sequence x[n] and a sequence y[n] that satisfy the condition of Equation 3 may be defined as shown in Equation 4.

$${r}_{x y} [ n ] = {\sum }_{m = - ∞}^{∞} x [ m + n ] {y}^{*} [ m ] \qquad [ Equation 4 ]$$

In Equation 4, m and n may denote variables for calculating the correlation between the sequence x[n] and the sequence y[n]. In addition, r_{xy}[n] in Equation 4 may be a sequence of length 2N−1 as defined in Equation 5.

$$\{ {r}_{x y} [ n ] \vert - N + 1 \leq n \leq N - 1 \} \qquad [ Equation 5 ]$$

If x[n]=y[n], where the x[n] and the y[n] are defined in Equations 1 and 2, Equation 4 represents autocorrelation.

If a periodic extension of x[n] defined in Equation 1 is denoted as x_{N}[n], the periodic extension x_{N}[n] may be defined as shown in Equation 6.

$$\begin{matrix}{x}_{N} [ n ] = x [ n mod N ] , & for all n\end{matrix} \qquad [ Equation 6 ]$$

According to the definition of Equation 6, the periodic cross-correlation between x[n] and y[n] as defined in Equations 1 and 2 may be defined as shown in Equation 7.

$${ρ}_{x y} [ n ] = {\sum }_{m = 0}^{N - 1} {x}_{N} [ m + n ] {y}_{N}^{*} [ m ] \qquad [ Equation 7 ]$$

In Equation 7, y′ may denote a complex conjugate of y_{N}.

The sequence p_{xy} of Equation 7 may be represented as in Equation 8, and may be a sequence having a period N.

$$\{ {ρ}_{x y} [ n ] \vert n = 0 , 1 , … , N - 1 \} \qquad [ Equation 8 ]$$

In the present disclosure, for comparison with the periodic correlation defined in Equation 7, the correlation in Equation 4 is referred to as ‘aperiodic correlation’.

The computation of aperiodic correlation as exemplified in Equation 4 may be a computationally expensive operation (O(N²)). Therefore, the computation of aperiodic correlation may be converted into a computation of periodic correlation through modification. When a sequence is converted into another sequence so that aperiodic correlation can be obtained through the computation of periodic correlation, computational cost may be reduced. Particularly, when using a fast Fourier transform (FFT) algorithm (O (N log N)), the computation may be performed more efficiently. Furthermore, expressing the computation of an aperiodic correlation as a computation of a periodic correlation may facilitate mathematical analysis of the sequence. If x[n] defined in Equation 1 is a sequence of complex numbers of length N, a corresponding sequence of length 2N through zero-padding may be defined as shown in Equation 9.

$${x}^{+ 0} [ n ] = \{ \begin{matrix}x [ n ] & for 0 \leq n \leq N - 1 ; \\ 0 & for N \leq n \leq 2 N - 1\end{matrix} \qquad [ Equation 9 ]$$

As defined in Equation 9, let x⁺⁰[n] and y⁺⁰[n] be the zero-padded sequences for x[n] defined in Equation 1 and y[n] defined in Equation 2, respectively. Then, a periodic correlation between x⁺⁰[n] and y⁺⁰[n] may be the same as the aperiodic correlation between x[n] and y[n].

### B. Definitions and Notations

If complex vectors xᵢ and x have a dimension of (N×1), an inner product between the complex vector xᵢ and the complex vector xⱼ may be defined as shown in Equation 10.

$$〈 {x}_{i} , {x}_{j} 〉 = {x}_{i}^{H} {x}_{j} \qquad [ Equation 10 ]$$

In Equation 10, a superscript H may denote a Hermitian transpose.

If e^{-jπ/N} is a primitive N-th root of unity, an (N×N) inverse discrete Fourier transform (IDFT) matrix may be defined as shown in Equation 11.

$${W}^{- 1} = \frac{1}{N} [ \begin{matrix}1 & 1 & … & 1 \\ 1 & 1 & … & {ω}^{- ( N - 1 )} \\ ⋮ & ⋮ & ⋱ & ⋮ \\ 1 & {ω}^{- ( N - 1 )} & … & {ω}^{- ( N - 1 ) ( N - 1 )}\end{matrix} ] \qquad [ Equation 11 ]$$

P_{N}^{k} may be an (N×N) permutation matrix defined as shown in Equation 12.

$${P}_{N}^{k} = {[ \begin{matrix}0 & 1 & 0 & ⋯ & 0 \\ 0 & 0 & 1 & … & 0 \\ ⋮ & ⋮ & ⋮ & ⋱ & ⋮ \\ 0 & 0 & 0 & … & 1 \\ 1 & 0 & 0 & … & 0\end{matrix} ]}^{k} \qquad [ Equation 12 ]$$

The permutation matrix of P_{N}^{k} may satisfy a condition in Equation 13.

$${( {P}_{N}^{k} )}^{T} = {( {P}_{N}^{k} )}^{- 1} = {P}_{N}^{- k} \qquad [ Equation 13 ]$$

For the sequence x[n] defined in Equation 1, let x_{N}[n] denote the periodic extension sequence with period N, and for the sequence y[n] defined in Equation 2, let y[n] denote the periodic extension sequence with period N. The periodic cross-correlation between x[n] and y[n] may be defined as shown in Equation 14.

$${ρ}_{xy} [ n ] = {\sum }_{m = 0}^{N - 1} {x}_{N} [ m + n ] {y}_{N}^{*} [ m ] = 〈 y , {P}_{N}^{n} x 〉 \qquad [ Equation 14 ]$$

In Equation 14, x and y may be defined as in Equations 15 and 16, respectively.

$$x = [ \begin{matrix}x [ 0 ] \\ ⋮ \\ x [ N - 1 ]\end{matrix} ] \qquad [ Equation 15 ]$$

$$y = [ \begin{matrix}x [ 0 ] \\ ⋮ \\ x [ N - 1 ]\end{matrix} ] \qquad [ Equation 16 ]$$

### [Desirable Characteristics of PSS Sequences]

As described above, a PSS sequence is a synchronization sequence. Therefore, in order to effectively function as a synchronization sequence, the PSS sequence needs to have the following important characteristics.

### <PSS Synchronization Characteristics>

(1) The PSS sequence needs to exhibit a low sidelobe level in an aperiodic autocorrelation of the PSS sequence.
(2) A low aperiodic cross-correlation level needs to be maintained between different PSS sequences.

The above two exemplified characteristics are essential for enabling reliable cell identification and preventing false detection during the initial cell search process. The characteristics of aperiodic correlation may be important factors since a terminal has not yet acquired system timing during the initial cell search procedure. The initial cell search procedure is a state in which the terminal has not yet acquired system timing-in other words, a state in which the terminal has not acquired downlink synchronization—and therefore may not know the position of an orthogonal frequency-division multiplexing (OFDM) symbols. Accordingly, the terminal needs to compute the position of the OFDM symbol in the time domain using tapped-delay-line filters based on the aperiodic correlation.

In general, a channel (or signal) transmitted in a mobile communication system may be transmitted to the terminal through a multipath channel. Therefore, a synchronization signal such as a PSS sequence may also be transmitted to the terminal through a multipath channel. In order for the terminal to receive the PSS sequence transmitted through a multipath channel, the influence of frequency-selective fading should be small. To reduce the influence of frequency-selective fading on the PSS sequence, it may be preferable to have a spectrally flat characteristic.

Another required characteristic of the PSS sequence may be a low PAPR. A high PAPR indicates a large ratio between peak power and average power, which may reduce efficiency of a power amplifier of the terminal. In particular, since the PSS sequence may be received before synchronization, a high PAPR may reduce a probability of detecting the PSS sequence. Therefore, the PSS sequence needs to have a low PAPR.

In addition, the PSS sequence needs to have strong tolerance to frequency offsets such as carrier frequency offset (CFO) and Doppler shift. In particular, the 6G communication system is expected to operate in a frequency band higher than the frequency bands used in the existing LTE, LTE-A, and 5G NR systems. Therefore, tolerance to frequency offsets such as CFO and Doppler shift, as described above, may be a more strongly required feature.

### [5G NR Sequences]

The PSS sequence currently used in 3GPP 5G NR is briefly described. The PSS sequence used in 5G NR is defined as in Equation 17.

$${d}_{pss 0} [ k ] = 1 - 2 s [ k ] \qquad [ Equation 17 ]$$

$${d}_{pss 1} [ k ] = 1 - 2 s [ ( k + 43 ) mod 127 ]$$

$${d}_{pss 2} [ k ] = 1 - 2 s [ ( k + 86 ) mod 127 ]$$

In Equation 17, s[k] may be an m-sequence of length 127 generated using a generator polynomial defined in Equation 19, when an initial state is defined as in Equation 18.

$$[ s [ 6 ] , s [ 5 ] , s [ 4 ] , s [ 3 ] , s [ 2 ] , s [ 1 ] , s [ 0 ] ] = [ 1 , 1 , 1 , 0 , 1 , 1 , 0 ] \qquad [ Equation 18 ]$$

$${x}^{7} + {x}^{4} + 1 \qquad [ Equation 19 ]$$

In 5G NR, the PSS may be transmitted (or broadcast) to the terminal using an OFDM symbol composed of 128 subcarriers. However, as can be seen from Equations 17 to 19, the length of the generated PSS sequence is 127. Therefore, the PSS sequence generated in 5G NR may be mapped to 128 available subcarriers in the frequency domain, and one remaining subcarrier may be zero-padded to form the OFDM symbol.

### [PSS Generation Method According to the Present Disclosure]

### A. PSS Sequence Design Method

Hereinafter, a PSS design method according to the present disclosure is described.

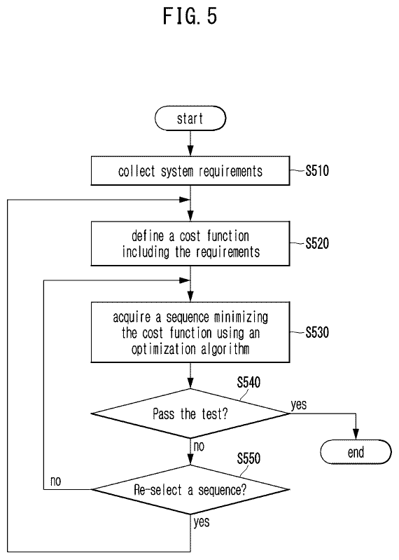

FIG. 5 is a flowchart illustrating a PSS sequence design method according to an exemplary embodiment of the present disclosure.

Before referring to FIG. 5, it should be noted that all or some of the procedures illustrated in FIG. 5 may be executed by a computer and/or a specific program, for example, AI. However, specific procedures may be performed by a developer through data input.

In step S510, the processor 311 of the computer may collect requirements of a wireless communication system to be developed. The requirements of the wireless communication system may be determined based on a frequency band to be used in the wireless communication system to be developed and/or characteristics of services to be provided by the wireless communication system. The frequency band to be used in the wireless communication system and/or the characteristics of services to be provided by the wireless communication system may be preconfigured by the developer. Accordingly, the processor 311 may collect the requirements by using the memory 312 and/or database 320 based on the frequency band to be used in the wireless communication system and/or the characteristics of services to be provided by the wireless communication system. The requirements in step S510 may be the same as the requirements described in step S410 above.

In step S520, the processor 311 may define a cost function including the requirements or based on the requirements. The cost function is described in more detail below.

In step S530, the processor 311 may acquire a sequence that minimizes the cost function using an optimization algorithm, for example, a gradient descent algorithm to be described below. The optimization algorithm for minimizing the cost function is also described in more detail below.

In step S540, the processor 311 may test the generated synchronization sequence, that is, the PSS. The testing of the PSS may be a procedure for verifying how well the generated PSS satisfies the requirements of the wireless communication system to be newly developed. When the test in step S540 is passed by satisfying a preconfigured condition, the procedure of FIG. 5 may be completed and the new PSS sequence may be obtained.

If the test in step S540 fails to satisfy the requirements considered in the PSS design—in other words, if the test is not passed—the processor 311 may determine in step S550 whether a cost function needs to be reselected. If the cost function needs to be reselected, the procedure may be performed again starting from step S520. If the cost function does not need to be reselected (i.e. if the currently determined cost function is usable), the processor 311 may acquire a sequence that minimizes the cost function again by using the optimization algorithm in step S530 (e.g. gradient descent algorithm to be described below).

Although the procedure of FIG. 5 has been described assuming that the procedure is performed by the computer, the procedure may also be performed directly by the developer. In addition, the computer 310 may perform the procedure directly or via a specialized program, for example, AI.

### B. Requirements

In the present disclosure, an example using some of the above-described numerous requirements is described. The following description is merely to aid in understanding the present disclosure and should not be construed as limiting the requirements to the ones exemplified below.

### <Requirements>

(1) A low sidelobe level (equal to or less than a predefined threshold) in aperiodic autocorrelation needs to be ensured.
(2) A low aperiodic cross-correlation level (equal to or less than a predefined aperiodic cross-correlation threshold) between different sequences needs to be maintained.
(3) A spectrally flat characteristic (within a predefined spectral flatness value) needs to be maintained.

The requirements (1) to (3) exemplified above may be regarded as minimum requirements for the PSS sequence. Since the 5G NR PSS sequence is derived from an m-sequence based on the evaluation criteria of the requirements (1) to (3), a minimum requirement set has been selected. Therefore, by comparing the characteristics of the requirements (1) to (3) with those of the 5G NR PSS sequence and an optimized PSS sequence, the efficiency of the PSS sequence design approach according to the present disclosure can be verified. However, the approach proposed in the present disclosure can easily add other desirable functions to the PSS sequence by simply redefining the cost function to include different requirements.

### C. Cost Function

The cost function described in step S520 of FIG. 5 is described in more detail. The objective in the present disclosure is to find a set of complex frequency-domain sequences. The set of sequences in the complex domain may be expressed as in Equation 20.

$$\{ {X}_{i} [ k ] \vert i = 0 , 1 , … , P - 1 ; k = 0 , 1 , … , N - 1 \} \qquad [ Equation 20 ]$$

Based on the PSS used in 5G NR, in Equation 20, the value of P may be 3 and the value of N may be 128. Therefore, Equation 20 may be inverse discrete Fourier transformed (IDFT) to be converted into the time domain as shown in Equation 21.

$$\{ {x}_{i} [ k ] \vert i = 0 , 1 , … , P - 1 ; k = 0 , 1 , … , N - 1 \} \qquad [ Equation 21 ]$$

Among the requirements (1) to (3) exemplified above, a cost function J may be defined to capture requirements (1) and (2) as shown in Equation 22.

$$J = {ω}_{a} {\sum }_{i = 0}^{P - 1} {{\sum }_{n = - ( N - 1 )}}_{n \neq 0}^{N - 1} {\vert {r}_{i i} [ n ] \vert}^{2 q} + {ω}_{c} {{\sum }_{i = 0}}^{P - 1} {\sum }_{{i = 0}_{j \neq i}}^{P - 1} {\sum }_{n = - ( N - 1 )}^{N - 1} {\vert {r}_{ij} [ n ] \vert}^{2 q} \qquad [ Equation 22 ]$$

In Equation 22, rᵢᵢ[n] denotes the aperiodic autocorrelation of the sequence defined in Equation 21, and rᵢⱼ[n] denotes the aperiodic cross-correlation of the sequence defined in Equation 21. According to the definition of Equation 21, J≥0. In Equation 22, q may be a parameter that determines the characteristics of the cost function J. When q=1, the cost function J may represent the total energy contained in the sidelobes of the autocorrelation function and the cross-correlation function. Therefore, minimizing the cost function may have the effect of minimizing the energy of the sidelobes in the autocorrelation and the energy of the cross-correlation.

The first term of Equation 22 is the sum of (2q)-th powers of all aperiodic autocorrelation sidelobes, and the second term of Equation 22 is the sum of (2q)-th powers of all aperiodic cross-correlations. In the present disclosure, by minimizing the cost function J, a sequence set with low sidelobe levels in aperiodic autocorrelations and low aperiodic cross-correlations between different sequences may be obtained. The parameter ωₐ and the parameter ω_{c} are weights associated with autocorrelation and cross-correlation, respectively. In the present disclosure, the case where ωₐ=ω_{c}=1 is assumed.

Although q may be an arbitrary positive value, it may be preferable to use an integer for easier handling of the cost function. A larger value of q imposes a greater penalty on large, sharp sidelobes and cross-correlation but may result in slower convergence. In the present disclosure, q may be assumed to be a positive integer.

Next, regarding the requirement (3), the frequency-domain sequence needs to have a modulus of 1, as shown in Equation 23.

$$\vert {X}_{i} [ k ] \vert = 1 , i = 0 , 1 , … , P - 1 , k = 0 , 1 , … , N - 1 \qquad [ Equation 23 ]$$

Meanwhile, the cost function given by Equation 22, as it is, may not be particularly useful. In other words, the cost function given by Equation 22 alone may not be suitable for deriving an optimization algorithm such as a gradient descent algorithm. In the present disclosure, in order to derive a gradient descent algorithm for optimizing sequences, a method of expressing the cost function in matrix form may be used.

Let xᵢ⁺⁰ denote the (2N×1) vector representation of xᵢ⁺⁰[n]. xᵢ⁺⁰[n] may be the zero-padded sequence of x[n] as defined in Equation 9. Based on the above relationship, xᵢ⁺⁰ may be expressed as shown in Equation 24.

$${x}_{i}^{+ 0} = {ZW}^{- 1} {X}_{i} \qquad [ Equation 24 ]$$

In Equation 24, W⁻¹ denotes an IDFT matrix, Xᵢ may be an (N×1) vector representation of Xᵢ[k], and Z may be a (2N×N) zero-padded matrix defined as

$$Z = [ \begin{matrix}{I}_{N} \\ {O}_{N}\end{matrix} ] .$$

As described in section A of the prerequisites, an aperiodic correlation may be expressed as a periodic correlation. From Equation 24, a relationship in Equation 25 may be defined.

$${r}_{i i} [ n ] = 〈 {x}_{i}^{+ 0} , {P}_{2 N}^{n} {x}_{i}^{+ 0} 〉 , {r}_{ij} [ n ] = 〈 {x}_{j}^{+ 0} , {P}_{2 N}^{n} {x}_{i}^{+ 0} 〉 \qquad [ Equation 25 ]$$

In Equation 25, P_{2N}ⁿ may denote a cyclic shift of a length−2N vector by n positions. By substituting Equation 10 into Equation 22 and substituting Equation 25 into Equation 24, a cost function in matrix form may be obtained as shown in Equation 26.

$$[ Equation 26 ]$$

$$J = {ω}_{a} {\sum }_{i = 0}^{P - 1} {\sum }_{{n = - ( M - 1 )}_{n \neq }}^{N - 1} {( {H}_{i}^{H} {Q}_{n}^{H} {X}_{i} {X}_{i}^{H} {Q}_{n} {X}_{i} )}^{q} + {ω}_{c} {\sum }_{i = 0}^{P - 1} {\sum }_{{j = 0}_{j \neq i}}^{P - 1} {\sum }_{n = - ( N - 1 )}^{N - 1} {( {X}_{i}^{H} {Q}_{n}^{H} {X}_{j} {X}_{j}^{H} {Q}_{n} {X}_{i} )}^{q}$$

In Equation 26, Qₙ may be expressed as in Equation 27, and Qₙ^{H} may be expressed as in Equation 28.

$${Q}_{n} = {( {W}^{- 1} )}^{H} {Z}^{T} {P}_{2 N}^{n} {ZW}^{- 1} \qquad [ Equation 27 ]$$

$${Q}_{n}^{H} = {Q}_{- n} \qquad [ Equation 28 ]$$

### D. Gradient Vector

The cost function J is a real multivariate polynomial function of (4q)-th order with respect to real and imaginary components of Xᵢ[k]. Therefore, the cost function J is an analytic function and has a minimum when the gradient vector ∇ᵢJ=0. Furthermore, the cost function J has a form of αx^{4q}+βx^{2q}, where α>0 and β>0, and is therefore a convex function with a unique minimum. The gradient vector ∇ᵢJ may be obtained as a derivative of the cost function J with respect to a complex vector Xᵢ*, as shown in Equation 29.

$${∇}_{i} J = 2 \frac{\partial J}{\partial {X}_{i}^{*}} = 2 {ω}_{a} q {\sum }_{\begin{matrix}n = - ( N - 1 ) \\ n \neq 0\end{matrix}}^{N - 1} {( {X}_{i}^{H} {Q}_{n}^{H} {X}_{i} {X}_{i}^{H} {Q}_{n} {X}_{L} )}^{q - 1} \times ( {Q}_{n}^{H} {X}_{i} {X}_{i}^{H} {Q}_{n} {X}_{i} + {Q}_{n} {X}_{i} {X}_{i}^{H} {Q}_{n}^{H} {X}_{i} ) + 2 {ω}_{c} q {\sum }_{\begin{matrix}j = 0 \\ j \neq i\end{matrix}}^{P - 1} {\sum }_{n = - ( N - 1 )}^{N - 1} {( {X}_{i}^{H} {Q}_{n}^{H} {X}_{j} {X}_{j}^{H} {Q}_{n} {X}_{i} )}^{q - 1} \times {Q}_{n}^{H} {X}_{j} {X}_{j}^{H} {Q}_{n} {X}_{i} \qquad [ Equation 29 ]$$

In Equation 29, i=0, 1, . . . , P−1. Although the gradient descent algorithm converges to the minimum of J, the minimum of J may not satisfy the requirement (3), and therefore Equation 32 may be used to satisfy the requirement (3).

### E. Gradient Descent Algorithm

As described in Equation 20, the parameters set to find complex frequency-domain sequences may be optimized using a gradient descent optimization algorithm. Initially, the parameters may be initialized as random phase modulus-1 sequences, as shown in Equation 30.

$${X}_{i} [ k ] = {e}^{j {φ}_{i , k}} \qquad [ Equation 30 ]$$

In Equation 30, φ_{i,k}˜U[0, 2π].

By using the Python codes shown in Table 1 below, the initial sequence exactly identical to the one used in the present disclosure may be generated. Here, P=3 and N=128, which may be the values set for the PSS of the 5G NR wireless communication system.

TABLE 1

```
import numpy as np
X_random = np.zeros((P, N), dtype=complex)
np.random.seed(1)
for p in range(P):
  for n in range(N):
    phi = np.random.uniform(0, 2*np.pi)
    X_random[p,n] = np.exp(1j * phi)
```

According to the present disclosure, an update rule of the gradient descent algorithm may consist of two steps. When the update rule of the gradient descent algorithm is expressed in matrix notation, the two steps may be defined as follows:

First step may be defined as in Equation 31.

Second step may be defined as in Equation 32.

$${X}_{i} : = {X}_{i} - μ {∇}_{i} J \qquad [ Equation 31 ]$$

$${X}_{i} [ k ] : = {X}_{i} [ k ] / \vert {X}_{i} [ k ] \vert \qquad [ Equation 32 ]$$

In Equation 31, ∇ᵢJ is the gradient vector obtained in Equation 29, and μ may be a convergence coefficient. In each iteration, all i may be updated for i=0, 1, . . . , P−1.

The value of μ in Equation 31 may be determined through heuristic schemes such as a trial-and-error process. Considering that the sequence search is intended as a one-time task within a specific application, such a heuristic approach may be considered acceptable. Moreover, practitioners in related fields including machine learning generally use the same heuristic approach.

During the iteration of the first and second steps of the update rule, the first step of the update rule may cause the sequence to deviate from a modulus-1 sequence. In addition, the second step may normalize the sequence, thereby eliminating the deviation by restoring the modulus-1 property of the sequence that has deviated in the first stage.

### F. Loss Curve

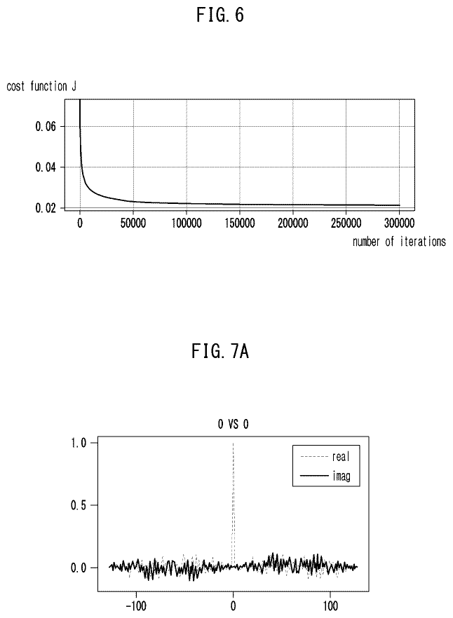

FIG. 6 is a graph illustrating a loss curve obtained through an optimization process using the gradient descent algorithm.

Before referring to FIG. 6, it is assumed that q=2 and the convergence coefficient μ=0.8. Referring to FIG. 6, the vertical axis may represent the cost function J, and the horizontal axis may represent the number of iterations. From the loss curve illustrated in FIG. 6, it can be seen that approximately 300,000 iterations are required for the cost function J to converge during the optimization process. The loss curve illustrated in FIG. 6 shows that the initial value of the cost function J starts at 0.070887 and converges to a final optimized value of 0.021111 after approximately 300,000 iterations.

Referring to the loss curve illustrated in FIG. 6, it can be observed that the cost function decreases sharply at first, but a rate of improvement slows significantly after about 20,000 iterations. This phenomenon may be due to the cost function including fourth-order correlation terms because q is set to 2. This may be confirmed from the definition of Equation 22 described above. The higher-order terms impose a larger penalty on large correlation values, which helps suppress random spikes and flatten the levels of (aperiodic autocorrelation sidelobes) and (cross-correlation). This is further described in an optimization performance section of the PSS.

The values of the cost function J for various PSS sequences may be exemplified as shown in Table 2.

TABLE 2

| 5G NR PSS | Random phase | Optimized |
|---|---|---|
| sequence | PSS sequence | PSS sequence |
| J = 0.063903 | J = 0.070887 | J = 0.021111 |

### [Performance of the Optimized PSS Sequence]

As described in the present disclosure, a PSS sequence may be obtained through the optimization process using the gradient descent algorithm. As an example of the PSS sequence obtained through the gradient descent algorithm according to the present disclosure, the Python code listings may be exemplified in Tables 3 to 15. It should be noted that Tables 3 to 15 represent continuous Python code listings.

```
TABLE 3
# The optimized PSS sequences in frequency domain import numpy as np
X = np.array(
  [[−0.92164679−0.38802988j, 0.51107303−0.85953729j,
  0.93462339+0.35563904j, 0.45246504+0.89178214j,
  0.80985965+0.58662368j, 0.48944219−0.87203575j,
  0.48063756+0.87691934j, −0.50078671+0.86557072j,
  −0.69171924+0.72216653j, −0.90786041−0.41927257j,
  −0.89021847+0.45553383j, 0.5674599 −0.82340104j,
  0.52621674+0.85035048j, 0.87481551−0.48445621j,
  0.94717526+0.32071643j, −0.91159581−0.41108768j,
```

TABLE 4

−0.3675871 +0.9299891j , −0.54261054+0.83998441j,
0.41060219+0.91181459j, 0.99691766+0.07845496j,
0.99453008−0.10445054j, 0.69789368−0.71620137j,
−0.64401026+0.76501685j, −0.32376857−0.94613631j,
0.87267033−0.48830984j, 0.98852231+0.15107493j,
0.89767008+0.44066815j, 0.98703393−0.16051173j,
0.04583788+0.99894889j, 0.99720536+0.07470925j,
0.68006852+0.73314856j, −0.50066607+0.86564051j,
0.97599802+0.21777941j, −0.99653417−0.08318448j,
0.11594911−0.99325516j, 0.66461482+0.74718615j,
0.58271619−0.81267573j, 0.79825197−0.60232366j,
0.98973958−0.14288305j, 0.77906083−0.62694835j,
0.89537179−0.44531938j, 0.62672 −0.77924453j,
0.11301724+0.99359303j, 0.15979439−0.98715032j,
0.99103414+0.13360888j, −0.93501619+0.35460503j,
0.70702925+0.70718431j, 0.76034751+0.64951648j,

TABLE 5

0.49643328+0.86807488j, 0.98439734+0.17595985j,
0.70764452−0.70656863j, −0.22254774−0.97492179j,
−0.65151476+0.75863596j, −0.99041456−0.13812676j,
−0.96801035+0.25091026j, 0.56932132+0.8221151j,
−0.91184785+0.41052831j, −0.6466797 +0.76276167j,
−0.94721619−0.32059552j, −0.95530474−0.29562283j,
−0.03683172+0.99932148j, 0.32170521+0.94683988j,
0.06081958−0.99814878j, −0.46280377+0.88646076j,
0.03087278+0.99952332j, −0.9349152 +0.3548712j,
−0.77936812−0.62656631j, −0.9164275 −0.40020074j,
0.17861322−0.98391937j, −0.79333521−0.60878506j,
0.82218532−0.56921991j, 0.99693955+0.07817634j,
−0.13928265−0.99025267j, 0.08898081−0.99603334j,
−0.79782708+0.60288635j, −0.72359235+0.69022758j,
0.97586258−0.21838548j, −0.67252723+0.74007238j,

TABLE 6

−0.37648859−0.92642125j, −0.36418765−0.93132559j,
0.13150471−0.99131555j, −0.72362808−0.69019012j,
−0.5887616 −0.80830674j, −0.94479444+0.32766365j,
−0.89010483+0.45575584j, 0.35895245−0.93335585j,
−0.92521226−0.37944996j, 0.77335896−0.63396839j,
−0.60831142−0.79369845j, −0.53254681−0.84640055j,
0.85689632−0.51548879j, 0.63223782+0.77477438j,
0.88505084−0.46549437j, −0.67875709−0.73436286j,
−0.1769533 +0.98421925j, −0.99930153+0.03736917j,
0.3757673 +0.92671405j, −0.94752383+0.31968514j,
0.85452225−0.51941479j, −0.97765089−0.21023495j,
−0.3307018 +0.9437353j, −0.80468234−0.59370559j,
−0.19845435−0.98011013j, −0.5480706 +0.83643207j,
0.83615395−0.54849482j, −0.9437244 −0.33073291j,
0.99632481+0.08565556j, 0.67740753−0.73560794j,
−0.70827439−0.70593724j, 0.24732158+0.96893345j,

TABLE 7

0.884472 +0.46659328j, −0.24079253−0.97057661j,
0.5668183 +0.82384284j, 0.93318282−0.35940204j,
−0.15204252−0.98837395j, 0.99818873−0.06016035j,
0.46470678−0.88546463j, 0.95898391−0.2834605j,
0.80358495−0.59519007j, 0.38295032−0.92376894j,
0.7686344 +0.63968833j, 0.94711846+0.32088413j,
0.59313238−0.80510495j, −0.79630353−0.60489725j,
−0.01503611−0.99988695j, 0.06235 −0.99805435j],
[ 0.75364425+0.65728254j, −0.97491076+0.22259607j,
−0.9629779 −0.26958034j, 0.51538701−0.85695754j,
−0.94698102−0.32128951j, 0.92477454+0.3805155j,
0.68711282−0.72655074j, 0.6364427 +0.77132398j,
−0.91592319−0.40135359j, −0.99688074+0.07892266j,
0.76517758−0.64381928j, 0.62817336−0.77807341j,
−0.99983222+0.0183178j, 0.84706695+0.53148619j,

TABLE 8

0.91791995−0.39676563j, 0.99173329−0.12831634j,
0.72616368+0.68752186j, −0.37635887+0.92647396j,
−0.28703253+0.95792084j, −0.99632733−0.08562622j,
−0.9963376 +0.08550661j, 0.99775762−0.06693079j,
0.96410905−0.26550656j, 0.93699649+0.34933876j,
0.96988003−0.24358311j, 0.48826631+0.87269468j,
−0.18088746+0.9835038j, −0.49471204−0.86905696j,
−0.70943115+0.70477475j, −0.86663781+0.49893777j,
0.59254984+0.80553379j, 0.9948511 −0.10134734j,
−0.41084156+0.91170676j, −0.75973109+0.65023739j,
−0.89945139−0.43702083j, 0.74609797−0.66583619j,
0.56924832+0.82216564j, 0.99657649+0.08267588j,
0.55290941+0.83324137j, −0.54164129+0.84060973j,
−0.98349484−0.18093619j, −0.88397035+0.46754296j,
−0.12872921+0.99167978j, 0.80579263−0.5921978j,
−0.84655811−0.53229631j, −0.74363536+0.66858541j,

TABLE 9

−0.9761042 +0.21730301j, −0.64843774−0.76126769j,
−0.66925987+0.74302842j, −0.48602859+0.87394291j,
−0.82730428+0.56175406j, −0.94602435+0.32409556j,
−0.93836174+0.34565481j, −0.98429696+0.17652052j,
−0.58939962−0.80784163j, 0.54396823+0.83910581j,
0.68059848+0.73265661j, 0.91228978−0.40954531j,
0.92672366−0.3757436j, 0.28932101−0.95723213j,
−0.78054389−0.62510098j, 0.86043792−0.50955528j,
0.34955399+0.93691622j, 0.92108765−0.3893553j,
0.75178774−0.65940518j, 0.45464278−0.89067387j,
0.54638398−0.83753481j, 0.88843104−0.45901012j,
0.43384946−0.90098538j, −0.34202385+0.93969127j,
−0.30529873−0.95225663j, 0.98372771+0.17966578j,

TABLE 10

0.68411479−0.72937436j, −0.40357505−0.91494654j,
0.41237545−0.91101399j, −0.29723206−0.95480527j,
−0.86192953−0.5070281j, −0.96120705−0.27582784j,
−0.98824895+0.15285288j, −0.98753699+0.1573871j,
0.54515646−0.83833432j, 0.83506059+0.55015799j,
−0.99490716+0.1007955j, 0.99868966−0.05117588j,
−0.11597236+0.99325244j, −0.03295598+0.9994568j,
0.94298603−0.33283231j, 0.13114101−0.99136372j,
0.74222146+0.67015468j, 0.79036609−0.61263483j,
0.25279003−0.96752116j, 0.97924259+0.20269175j,
−0.54141986+0.84075236j, −0.98803873−0.1542059j,
0.52234058+0.85273696j, 0.24806921−0.96874231j,
0.9333814 −0.35888599j, 0.10081886−0.9949048j,
−0.76750282−0.64104557j, 0.97315961−0.23013122j,
−0.14042871−0.99009079j, −0.39205122−0.91994339j,

TABLE 11

−0.98838414−0.15197628j, −0.98678758−0.16201937j,
−0.43707766−0.89942377j, 0.00565202+0.99998403j,
−0.90063394+0.43457853j, −0.96898694+0.24711196j,
0.82423809−0.56624339j, 0.16232113−0.98673799j,
−0.9859261 −0.16718174j, −0.70989421−0.70430833j,
0.86883846+0.49509568j, 0.97470707−0.2234863j,
−0.49866282−0.86679605j, −0.8261286 +0.56348162j,
0.33647813−0.94169128j, 0.05019976−0.9987392j,
0.91185639−0.41050935j, −0.97190561−0.23537094j,
−0.34098707−0.94006799j, 0.99158488+0.12945821j,
0.86180339+0.50724246j, 0.62484099+0.78075203j,
0.93835212+0.34568093j, 0.99091677+0.13447661j,
−0.54606089−0.83774549j, −0.39538135−0.91851706j],
[−0.75953296−0.65046882j, −0.81859114−0.57437666j,
−0.65973103+0.75150181j, −0.96962223+0.2446073j,
0.57956375−0.81492691j, 0.56623291−0.82424529j,

TABLE 12

−0.38597061−0.92251108j, 0.3876874 −0.92179091j,
−0.18500414−0.98273774j, −0.95502187−0.29653538j,
−0.91688629−0.39914851j, −0.99924377−0.03888297j,
−0.90967865−0.41531284j, −0.60238567−0.79820518j,
−0.80789541+0.5893259j, −0.5057491 +0.86268062j,
−0.99690448−0.07862219j, −0.39541624+0.91850204j,
−0.24641784−0.96916368j, −0.92210285−0.38694488j,
0.00481255+0.99998842j, −0.59650904+0.80260636j,
0.56027326+0.82830784j, −0.10875331−0.99406877j,
0.78440447+0.62024966j, 0.93776089−0.34728161j,
−0.53285412−0.84620712j, −0.56281406+0.82658353j,
−0.19227563+0.98134096j, 0.83303871−0.55321471j,
−0.9741713 −0.22581027j, −0.03681754−0.999322j,
−0.21141458−0.97739648j, −0.3506887 −0.93649209j,
−0.93010038−0.36730545j, −0.05439817−0.99851932j,
−0.05859053−0.9982821j, −0.79778907+0.60293665j,

TABLE 13

0.44905647+0.89350338j, 0.7460577 −0.66588131j,
−0.85517541+0.51833871j, 0.9867445 −0.16228154j,
0.96813955−0.25041128j, 0.96124782+0.27568575j,
0.9995444 +0.03018269j, 0.92045855−0.39084019j,
−0.46120138−0.88729549j, −0.98345217+0.18116795j,
0.80936215+0.5873099j, −0.583279 +0.81227188j,
−0.31852146+0.94791565j, −0.11727311+0.9930997j,
−0.43015832+0.90275346j, 0.28993434+0.95704654j,
0.55999037+0.82849911j, 0.38668239+0.92221295j,
0.32390921+0.94608817j, 0.19799709+0.98020261j,
−0.19228599+0.98133893j, −0.95794959+0.28693654j,
−0.21516709−0.97657725j, 0.46514458+0.88523473j,
0.90674747+0.42167407j, 0.99553173−0.09442763j,
−0.87487405−0.48435049j, −0.80227207+0.59695857j,
0.49324697+0.86988932j, 0.0075322 −0.99997163j,
−0.44381601+0.89611793j, −0.89549705−0.44506746j,

TABLE 14

−0.74843679−0.66320613j, 0.27874525−0.96036508j,
−0.1352487 +0.99081168j, 0.99928833−0.03772035j,
0.99034927−0.1385941j, −0.29666078−0.95498292j,
−0.34090201−0.94009883j, 0.93489868+0.35491471j,
−0.11108325+0.99381111j, 0.78558526+0.61875342j,
0.01697802−0.99985586j, −0.99436667−0.1059949j,
0.99719446+0.07485462j, 0.92799565−0.37259104j,
0.94061739−0.33946859j, 0.7214353 −0.69248185j,
−0.425465 +0.90497488j, −0.7510183 −0.66028139j,
0.2943795 −0.95568861j, −0.75832265−0.65187941j,
−0.52298794−0.85234008j, 0.37846026−0.92561754j,
−0.83228794−0.55434356j, −0.11524055−0.99333761j,
0.98163921−0.1907471j, 0.70710102+0.70711254j,
0.0897062 −0.99596827j, −0.75529835+0.65538111j,
0.96045072−0.27845001j, −0.99034724+0.13860861j,
−0.01474048−0.99989135j, 0.97794489+0.2088631j,

TABLE 15

−0.45006881+0.89299388j, 0.99599216+0.08944061j,
0.72558996−0.68812732j, −0.36874279+0.92953147j,
0.88087607+0.47334696j, 0.92130271−0.38884613j,
0.84046554+0.541865j, −0.94833628+0.31726691j,
−0.92969933−0.36831936j, 0.97396789+0.22668603j,
−0.39016119+0.92074657j, 0.99572278+0.09239122j,
0.9172584 +0.39829263j, 0.08135331−0.99668533j,
0.33217033+0.94321942j, −0.23480405+0.97204272j,
−0.80728514−0.59016159j, −0.48290729−0.87567148j,
0.42772202−0.90391032j, 0.29314122+0.95606915j,
−0.58504465+0.81100109j, −0.759791 +0.65016739j,
0.25380647+0.96725502j, −0.99948188−0.03218655j]])

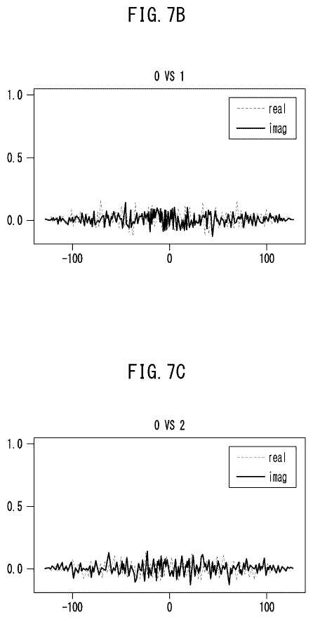

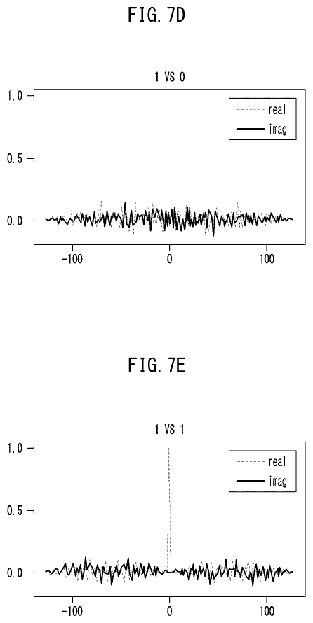

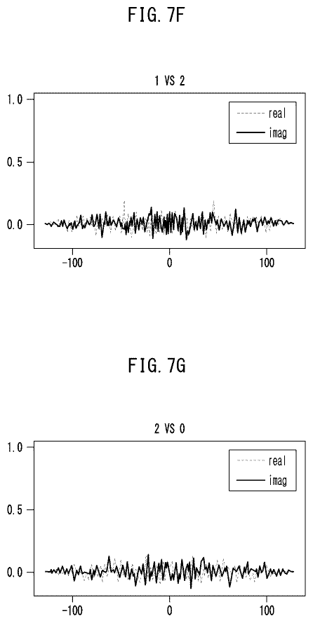

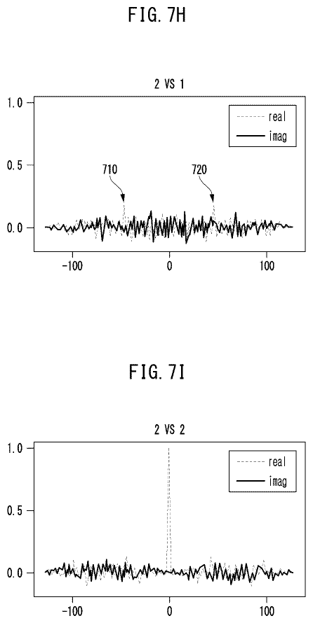

FIGS. 7A to 7I are graphs illustrating aperiodic correlation (autocorrelation) functions of 5G NR PSS sequences.

More specifically, FIG. 7A is a graph of an aperiodic correlation (autocorrelation) function between the zeroth PSS and the zeroth PSS among the 5G NR PSS sequences, FIG. 7B is a graph of an aperiodic correlation (cross-correlation) function between the zeroth PSS and the first PSS, FIG. 7C is a graph of an aperiodic correlation (cross-correlation) function between the zeroth PSS and the second PSS, FIG. 7D is a graph of an aperiodic correlation (cross-correlation) function between the first PSS and the zeroth PSS, FIG. 7E is a graph of an aperiodic correlation (autocorrelation) function between the first PSS and the first PSS, FIG. 7F is a graph of an aperiodic correlation (cross-correlation) function between the first PSS and the second PSS, FIG. 7G is a graph of an aperiodic correlation (cross-correlation) function between the second PSS and the zeroth PSS, FIG. 7H is a graph of an aperiodic correlation (cross-correlation) function between the second PSS and the first PSS, and FIG. 7I is a graph of an aperiodic correlation (cross-correlation) function between the first PSS and the second PSS.

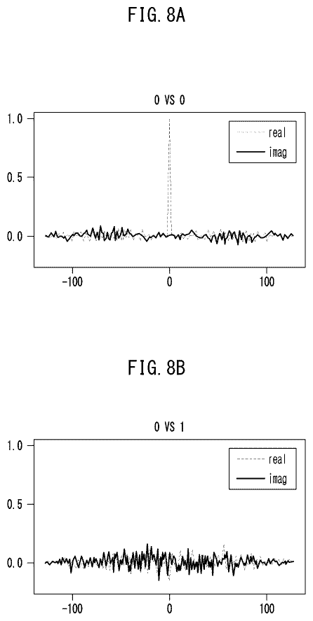

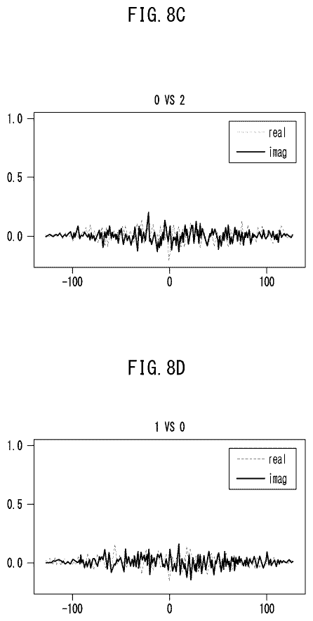

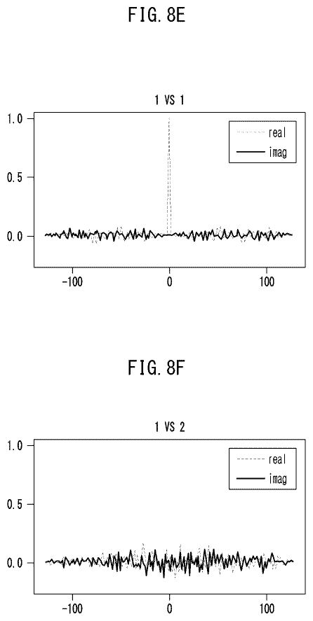

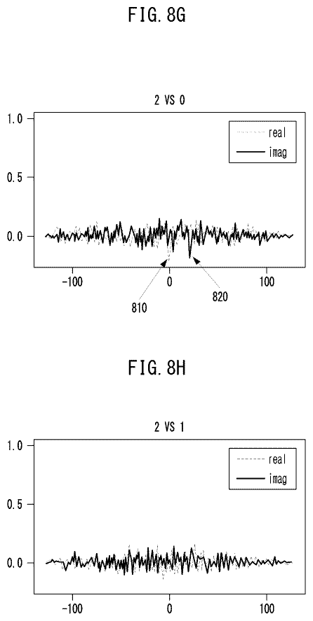

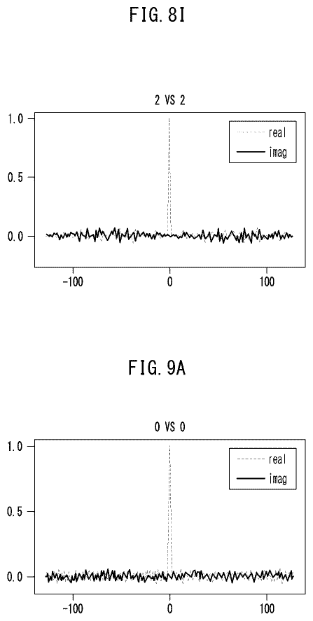

FIGS. 8A to 8I are graphs illustrating aperiodic correlation (autocorrelation) functions of random phase sequences.

More specifically, FIG. 8A is a graph of an aperiodic correlation (autocorrelation) function between the zeroth random phase signal and the zeroth random phase signal among the random phase PSS sequences, FIG. 8B is a graph of an aperiodic correlation (cross-correlation) function between the zeroth random phase signal and the first random phase signal, FIG. 8C is a graph of an aperiodic correlation (cross-correlation) function between the zeroth random phase signal and the second random phase signal, FIG. 8D is a graph of an aperiodic correlation (cross-correlation) function between the first random phase signal and the zeroth random phase signal, FIG. 8E is a graph of an aperiodic correlation (autocorrelation) function between the first random phase signal and the first random phase signal, FIG. 8F is a graph of an aperiodic correlation (cross-correlation) function between the first random phase signal and the second random phase signal, FIG. 8G is a graph of an aperiodic correlation (cross-correlation) function between the second random phase signal and the zeroth random phase signal, FIG. 8H is a graph of an aperiodic correlation (cross-correlation) function between the second random phase signal and the first random phase signal, and FIG. 8I is a graph of an aperiodic correlation (cross-correlation) function between the second random phase signal and the second random phase signal.

The random phase sequences illustrated in FIGS. 8A to 8I may be the sequences used to initialize the gradient descent algorithm before optimization.

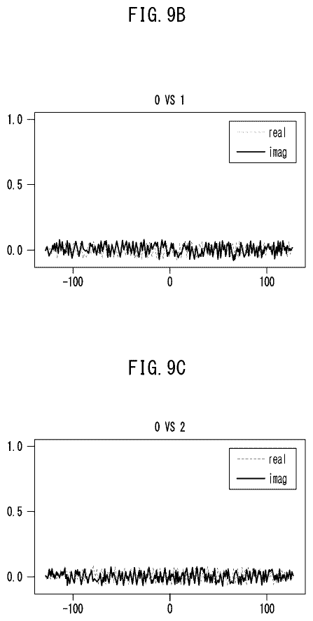

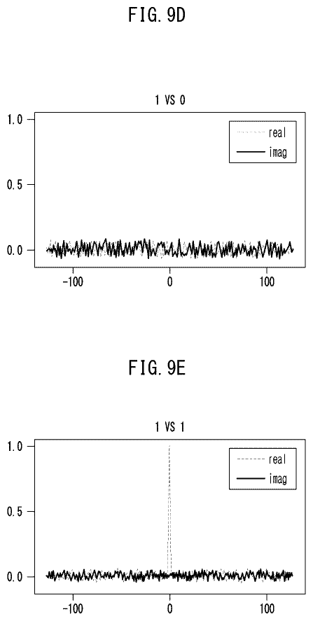

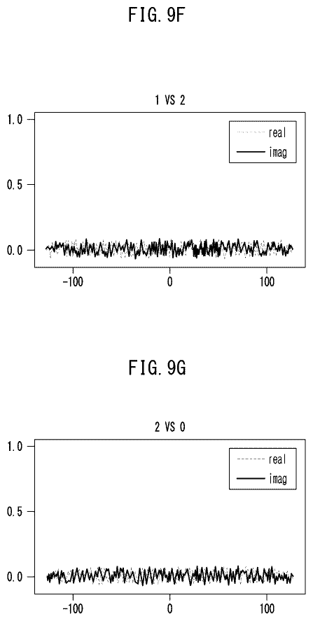

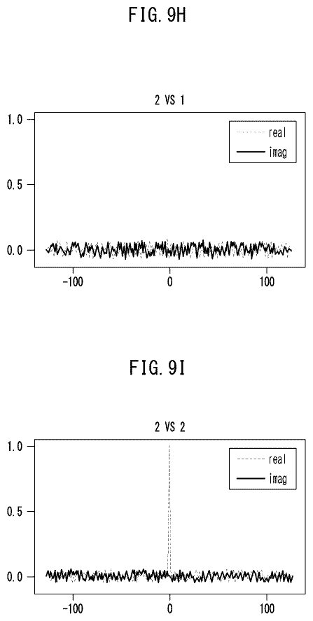

FIGS. 9A to 9I are graphs illustrating aperiodic correlation (autocorrelation) functions of optimized PSS sequences according to the present disclosure.

More specifically, FIG. 9A is a graph of an aperiodic correlation (cross-correlation) function between the zeroth optimized PSS and the zeroth PSS, FIG. 9B is a graph of an aperiodic correlation (cross-correlation) function between the zeroth optimized PSS and the first optimized PSS, FIG. 9C is a graph of an aperiodic correlation (cross-correlation) function between the zeroth optimized PSS and the second optimized PSS, FIG. 9D is a graph of an aperiodic correlation (cross-correlation) function between the first optimized PSS and the zeroth optimized PSS, FIG. 9E is a graph of an aperiodic correlation (cross-correlation) function between the first optimized PSS and the first optimized PSS, FIG. 9F is a graph of an aperiodic correlation (cross-correlation) function between the first optimized PSS and the second optimized PSS, FIG. 9G is a graph of an aperiodic correlation (cross-correlation) function between the second optimized PSS and the zeroth optimized PSS, FIG. 9H is a graph of an aperiodic correlation (cross-correlation) function between the second optimized PSS and the first optimized PSS, and FIG. 9I is a graph of an aperiodic correlation (cross-correlation) function between the second optimized PSS and the second optimized PSS.

From the simulation graphs of FIGS. 7A to 7I, it can be observed that the aperiodic autocorrelation (diagonal graph) of the 5G NR PSS sequences exhibits meaningful sidelobes accompanied by random spikes. It can also be confirmed that the aperiodic cross-correlation of the 5G NR PSS sequences shows higher values and more irregularities with larger spikes than the sidelobes of the autocorrelation. As seen in FIGS. 7A to 7I, spikes in the 5G NR PSS sequences may be misunderstood by the terminal as peaks of the correlation during cell search.

In FIG. 7H, reference numerals 710 and 720 denote prominent spikes, which may be misunderstood as correlation peaks. In addition, in FIG. 8G, reference numerals 810 and 820 denote prominent spikes, which may also be misunderstood as correlation peaks.

However, for the optimized PSS sequences according to the present disclosure, it can be observed that no spikes that may be misunderstood as peaks occur.

In addition, the random phase sequences exhibit correlation performance similar to the 5G NR PSS sequences. A comparative analysis between FIGS. 7A to 7I and FIGS. 8A to 8I reveals that the random phase sequences show slightly better autocorrelation characteristics than the 5G NR PSS sequences, while the 5G NR PSS sequences show better cross-correlation characteristics than the random phase sequences.

The cost function J, which serves as a quantitative performance metric used in the optimization of the present disclosure, also supports these observations. The PSS sequences used in 5G NR produce the cost function J of 0.063903. The cost function J of the 5G NR PSS sequence may be considered relatively large. On the other hand, the cost function J of the random phase sequence is approximately 0.070887.

The correlation performance of the optimized PSS sequence according to the present disclosure is illustrated in FIGS. 9A to 9I. As can be seen in FIGS. 9A to 9I, the sidelobes of the aperiodic autocorrelation are small, and in the case of the aperiodic cross-correlation, the correlation values are overall low regardless of the peaks and sidelobes. In general, small sidelobes are favorable for autocorrelation, and overall low values are preferable for cross-correlation regardless of peaks and sidelobes. More importantly, the autocorrelation and cross-correlation values are highly uniform without spikes. The absence of spikes is a very preferable property for a synchronization sequence, because spikes may be misunderstood as correlation peaks by the terminal during cell search, leading to synchronization errors and performance degradation.

The absence of spikes results from setting q to 2, which may impose a greater penalty on spikes. On the other hand, using q=1 may produce more irregular correlation characteristics and frequent spikes. Since the case of q=1 would require excessive description, description thereon is omitted. However, it should be noted that the optimization may also be performed in the same manner using the gradient descent algorithm according to the present disclosure when q=1, and similar results may be obtained.

Furthermore, it can be seen that the method for designing a PSS sequence using the gradient descent optimization described above in the present disclosure may generate PSS sequences with excellent aperiodic autocorrelation and cross-correlation characteristics. In particular, simulation confirms that the performance is superior to the PSS sequences currently used in 5G NR. The approach of PSS sequence design using gradient descent optimization according to the present disclosure can explicitly integrate the synchronization sequence requirements into the design process and thereby guarantee excellent performance.

The method proposed in the present disclosure may also be used to design PSS sequences with additional functionalities such as increased tolerance to frequency offset, simply by including additional requirements in the definition of the cost function. In addition, the PSS design method according to the present disclosure can flexibly generate sequences of arbitrary length or more than three sequences (P>3). Furthermore, the PSS generation method according to the present disclosure is not limited to synchronization sequence design. Since the method is applicable to any sequence design with clearly defined requirements, it may be a powerful and highly adaptive method. The PSS design method according to the present disclosure may be used for designing PSS sequences to be used in next-generation mobile communication systems.

Meanwhile, the above has described the PSS design method. However, the present disclosure may also apply when a base station transmits the optimized PSS obtained by the described PSS design method. In addition, the present disclosure may also apply to the case where synchronization is performed by a user equipment (UE) using the optimized PSS.

### [PSS Sequence Detection]

A method for improving PSS sequence detection in the 5G NR system is described below.

Currently, the 5G NR PSS sequence has non-optimal correlation characteristics that are similar to those of a random phase sequence. To address these limitations without modifying the existing 5G NR network infrastructure or terminal, the present disclosure describes a method for designing a new detector that compensates for the shortcomings of the current PSS sequence, as well as a PSS detection apparatus.

The present disclosure further provides a method using a non-matched filter together with an auxiliary sequence. In the present disclosure, this problem may be formulated as an optimization problem with linear constraints.

In 5G NR, a PSS sequence may serve to provide timing information and a cell ID in the mobile communication system. Therefore, the performance of the PSS sequence may affect the overall performance of the system. However, the correlation property of the 5G NR PSS sequence is far from optimal. In fact, the performance of the 5G NR PSS sequence may be similar to that of a random phase sequence. Replacing the current 5G NR PSS sequence with an improved sequence may be unrealistic because doing so would require updating all mobile devices currently in use. As a solution to this issue, a detection apparatus and a detection method that can compensate for the drawbacks of the 5G NR PSS sequence may be provided. The present disclosure provides a detection apparatus and detection method that can compensate for the drawbacks of the 5G NR PSS sequence.

By using the detection apparatus and detection method that can compensate for the drawbacks of the 5G NR PSS sequence according to the present disclosure, it is possible to improve the detection performance of the PSS without modifying the existing 5G NR network and/or terminals. In addition, since there is no change to the network, there is an advantage that terminals are not affected.

### [Assumptions for PSS Sequence Detection]

For the detection apparatus and detection method that can compensate for the drawbacks of the 5G NR PSS sequence according to the present disclosure, the following assumptions may be made.
(1) A base station (BS) operates based on the 5G NR technical specifications. In other words, each BS transmits one of the three 5G NR PSS sequences.
(2) Since there are three PSS sequences, each terminal has at least one correlator for each of the PSS sequences, resulting in a total of three or more correlators.
(3) Each correlator included in the terminal may detect a PSS sequence using all sequences. All sequences may refer to any one of the sequences based on performance, and may refer to any sequence that shows good performance. As one option, a sequence identical to the one transmitted by the BS may be used, which is equivalent to using a matched filter that maximizes output SNR under a white Gaussian noise environment. As another option, a sequence with improved cross-correlation characteristics may be used to minimize false detections.
(4) When a peak occurs in one of the three correlators, the corresponding PSS sequence may be considered to be detected.

### [PSS Sequence Detection Apparatus]

A detection apparatus according to the present disclosure is described below.

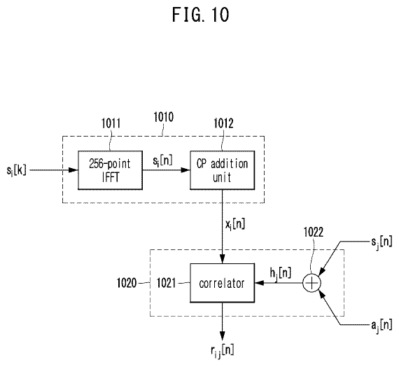

FIG. 10 is a conceptual diagram illustrating an apparatus for detecting a 5G NR PSS sequence according to the present disclosure.

Before describing FIG. 10, it should be noted that for convenience of description, noise and interference signals at the input and output of the correlator are not illustrated. It should be noted that FIG. 10 only illustrates an apparatus for PSS transmission at a base station 1010 and an apparatus for PSS detection at a terminal 1020.

Referring to FIG. 10, the base station 1010 may include a 256-point IFFT device 1011 and a cyclic prefix (CP) addition unit 1012. The terminal 1020 may include an adder 1022 and a correlator 1021. The correlator 1021 illustrated in FIG. 10 may be a cross-correlator. In the following description of FIG. 10, the correlator 1021 may be understood as a cross-correlator.

Sᵢ[k], expressed as the input to the 256-point Inverse Fast Fourier Transform (IFFT) 1011, may be the i-th PSS sequence in the frequency domain and may be expressed as shown in Equation 33 below.

$${S}_{i} [ k ] , k = 0 , 1 , … , L - 1 , \qquad [ Equation 33 ]$$

$$i ∈ \{ 0 , 1 , … , P - 1 \}$$

In Equation 33, L may denote the length of the PSS sequence. Since the length of the PSS sequence in 5G NR is 128, the value of L may be 127. In addition, i denotes an index of the PSS sequence in 5G NR, so the value of P may be 3.

The 256-point IFFT 1011 may perform zero-padding before performing the 256-point IFFT on the input Sᵢ[k], and may output an OFDM symbol sᵢ[n] of length 256 by performing the 256-point IFFT. The OFDM symbol sᵢ[n] of length 256 may represent the i-th PSS sequence in the time domain.

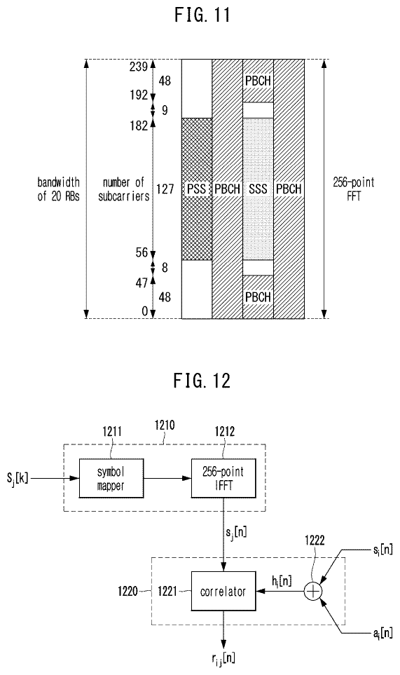

FIG. 11 is a conceptual diagram illustrating a structure of an SSB transmitted by a base station based on the 5G NR technical specifications.

Referring to FIG. 11, it can be seen that an SSB is composed of the first OFDM symbol in which a PSS is transmitted in the time domain, the second OFDM symbol in which only a PBCH is transmitted, the third OFDM symbol in which an SSS and the PBCH are transmitted, and the fourth OFDM symbol in which only the PBCH is transmitted. From the frequency domain perspective, the SSB may be transmitted over 20 resource blocks (RBs), and if the lowest RB is the 0-th RB, the PSS may be transmitted from the 56th RB to the 182nd RB. In other words, the PSS may be transmitted through 127 RBs. The SSB transmitted in the third OFDM symbol may also be transmitted from the 56th RB to the 182nd RB. The third OFDM symbol may be configured to have a guard band between the SSS and PBCH. Therefore, the PBCH included in the third OFDM symbol may be allocated to RBs from the 0th to the 47th, and the subsequent 8 RBs may be used as a guard band. In addition, the PBCH included in the third OFDM symbol may be allocated to RBs from the 192nd to the 239th. Therefore, 9 RBs from the 183rd to the 191st after the 182nd RB in which the SSS transmitted may be used as the guard band. As illustrated in FIG. 11, the PSS and SSS may be mapped (positioned) at the center of the RBs used for SSB transmission.

The OFDM symbol sᵢ[n], which is the i-th PSS sequence in the time domain, may be input to the CP addition unit 1012. The CP addition unit 1012 may add a CP to the OFDM symbol sᵢ[n] of length 256. Therefore, the OFDM symbol output from the CP addition unit 1012 may be an OFDM symbol with a CP, which may be expressed as xᵢ[n].

Through the procedure described above, the base station may configure the i-th PSS sequence into an OFDM symbol with a CP and broadcast it in an SSB transmission occasion.

Meanwhile, hⱼ[n], which is the output of the adder 1022 in FIG. 10, may be a sequence used in the cross-correlator 1022 included in the terminal. The coefficients hⱼ[n], which are the output of the adder 1022, may be defined as shown in Equation 34 below.

$${h}_{j} [ n ] = {s}_{j} [ n ] + {a}_{j} [ n ] \qquad [ Equation 34 ]$$

$$j = 0 , 1 , … , P - 1$$

In Equation 34, sⱼ[n] may be the OFDM symbol in the time domain corresponding to the j-th PSS sequence, and aⱼ[n] may be an auxiliary sequence that assists in the detection of the j-th PSS sequence. Therefore, as illustrated in FIG. 10, sⱼ[n] and aⱼ[n] may be added by the adder 1022 to generate hⱼ[n]. If aⱼ[n]=0, the cross-correlator may be reduced to a matched filter.

The objective of the auxiliary sequence in the present disclosure may be to improve the characteristics of the cross-correlator 1022 without interfering with the detection of the PSS sequence. In order to prevent interference between the auxiliary sequence and the PSS sequence, the auxiliary sequence aⱼ[n] may be orthogonal to the OFDM symbol s; [n] in the time domain corresponding to the j-th PSS sequence, as expressed in Equation 35 below.

$${a}_{j} [ n ] ⊥ {s}_{j} [ n ] , \qquad [ Equation 35 ]$$

$$j = 0 , 1 , … , P - 1$$

The cross-correlator 1022 may output a cross-correlation value rᵢⱼ[n] by performing correlation between the OFDM symbol xᵢ[n] of the i-th PSS sequence broadcasted by the base station and the sequence hⱼ[n] used in the cross-correlator 1022. The cross-correlation value rᵢⱼ[n], which is the output of the cross-correlator 1022, may be expressed as shown in Equation 36 below.

$${r}_{i j} [ n ] = {\sum }_{m = 0}^{N - 1} {x}_{i} [ m + n ] {h}_{j}^{*} [ m ] \qquad [ Equation 36 ]$$

In Equation 36, −(N−1)≤n≤N+N_{cp}−1, N_{cp} denotes the length of the CP, and N may be 256. rᵢⱼ[n] may have a maximum value when j=i and n=N_{cp}.

Based on the above definitions, in order to improve the performance of the correlator according to the present disclosure, in other words, in order to more efficiently detect the 5G NR PSS, the problem may be solved by finding an optimal auxiliary sequence aⱼ[n], j=0, . . . , P−1, that provides improved cross-correlation characteristics.

### [Cost Function for PSS Sequence Detection]

As described above, in order to find an optimal auxiliary sequence aⱼ[n], the present disclosure may define a cost function as shown in Equation 37 below. In the present disclosure, the term ‘cost’ may refer to ‘cost function’. Therefore, any portion described as a cost should be interpreted as a cost function.

$$J = \text{} {w}_{a} \text{} {\sum }_{i = 0}^{P - 1} {\sum }_{\begin{matrix}n = - ( N - 1 ) \\ n \neq {N}_{cp}\end{matrix}}^{N + {N}_{cp} - 1} {\vert {r}_{i i} [ n ] \vert}^{2 q} + {w}_{c} {\sum }_{i = 0}^{P - 1} {\sum }_{\begin{matrix}j = 0 \\ j \neq i\end{matrix}}^{P - 1} {\sum }_{\begin{matrix}n = - ( N - 1 ) \\ n \neq {N}_{c p}\end{matrix}}^{N + {N}_{c p} - 1} {\vert {r}_{i j} [ n ] \vert}^{2 q} \qquad [ Equation 37 ]$$

In Equation 37, it can be seen that J is composed of a sum of two components. The first component may be a sum of costs related to sidelobes of the autocorrelation of the i-th PSS sequence, and the second component may be a sum of costs related to cross-correlation between the i-th and j-th PSS sequences. The components may be weighted by parameters wₐ and w_{c}, respectively. The parameter q may be a value for determining a severity of penalty for larger cost values in the cost function J. In other words, the parameter q may be a penalty severity determination factor for the cost function J. In order to ensure that the auxiliary sequence aⱼ[n] does not interfere with the detection of the PSS sequence, the constraint condition given in Equation 35 may be applied.

This may be a classical optimization problem with linear constraints. There may exist a substantial amount of literature for solving such problems. In the present disclosure, for this specific problem, a closed-form solution may be derived when the penalty severity determination factor is q=1. However, when q>1, an iterative method may be required to find the optimal value of aⱼ[n].

In the present disclosure described below, solutions for resolving the above-mentioned additional problems will be described. The present disclosure described below may include the following results.
(1) A closed-form solution for q=1 and an iterative solution for q>1.
(2) A detector with enhanced correlation characteristics instead of one based on maximum output SNR is described. Since detection depends not only on the peak magnitude of the cross-correlator but also on the overall profile of the cross-correlation, the method described below is expected to show better performance than existing methods in most scenarios. However, if the SNR of the channel becomes very low, the proposed approach may struggle, and there may exist a threshold below which existing methods focusing on maximizing output SNR become more advantageous.
(3) An analytical study on the existence of a global optimum may be conducted. This may include rigorous mathematical analysis of the characteristics of the cost function, including convexity.

Then, the following describes an optimization method for PSS detection, which introduces optimized correlation coefficients that integrate auxiliary sequences to minimize sidelobes of the autocorrelation and cross-correlation, without changing the currently defined 5G NR PSS sequences in the 3GPP technical specifications. A convex optimization framework may employ various optimization methods based on parameters that control penalties for sidelobes and cross-correlation. The present disclosure may include both closed-form solutions and iterative algorithms based on projected gradient descent (PGD).

As described above in FIG. 11, the PSS may have a sequence of length 127. Furthermore, as described above, the PSS may consist of one of P=3 possible sequences and may be derived by cyclically shifting a single m-sequence of length 127. As can be seen in FIG. 11, the PSS may be mapped to 127 active subcarriers located at the center of an SSB bandwidth. A primary function of the PSS, which is periodically transmitted as a part of the SSB, is to support downlink frame synchronization and to allow a terminal (e.g. UE) to determine a boundary of a radio frame. The PSS may also be used to detect a part of a physical layer cell identifier (PCI).

Although the SSB is intended to provide robust synchronization functionality, the current 5G NR PSS sequence may, in some cases, perform worse than a random phase sequence. Such results may be unexpected considering the rigorous 3GPP standardization process. Since the PSS sequence has already been widely deployed in global 5G NR networks, changing it may not be a feasible option. In light of such constraints, as described above, it may be necessary to optimize the detector without changing the current PSS sequences based on the 5G NR technical specifications.

Currently, most PSS detectors used in terminals (e.g. UEs) use correlators with coefficient vectors identical to sequences to be detected. The PSS detector may detect a PSS by identifying whether a peak output occurs based on the presence of a specific PSS sequence. In an Additive White Gaussian Noise (AWGN) channel, which is widely assumed in communication systems, such a correlation process may be mathematically equivalent to a matched filter, which is an optimal linear filter that maximizes an SNR at the output peak.

The present disclosure described below provides a method of using optimized correlator coefficient vectors that are designed to improve detection performance by forming the overall profile of the correlation function while using a correlator. The optimized correlator coefficient vectors may be determined by minimizing a specifically defined objective function using an optimization algorithm.

### [PSS Detection Method According to the Present Disclosure]

### A. PSS Detection Structure

FIG. 12 is another conceptual diagram illustrating an apparatus for detecting a 5G NR PSS sequence according to the present disclosure.

FIG. 12 may represent a modified configuration of the base station 1210 previously described in FIG. 10. It should be noted that this is for convenience of description of the present disclosure.

Referring to FIG. 12, a base station 1210 may include a symbol mapper 1211 and a 256-point IFFT 1212, and a terminal 1220 may include an adder 1222 and a correlator 1221, identically to FIG. 10.

Sⱼ[k], expressed as the input to the symbol mapper 1211, may be one of P=3 frequency-domain PSS sequences, each of length 127. The sequence Sⱼ[k] input to the symbol mapper 1211 may be mapped by the symbol mapper 1211 to 127 central subcarriers within an SSB, as illustrated in FIG. 11. The sequence mapped to the subcarriers needs to be transformed into a time-domain PSS sequence in order to be transmitted to the terminal 1220 via a wireless channel. Therefore, the sequence output from the symbol mapper 1211 may be transformed into a time-domain sequence sⱼ[n] of length 256 (where N=256) by the 256-point IFFT 1212. The time-domain sequence sⱼ[n] of length 256 generated by the 256-point IFFT 1212 may be transmitted from the base station 1210 to the terminal 1220.

In FIG. 12, it should be noted that analog processes such as pulse shaping and analog-to-digital conversion are omitted to emphasize digital signal processing and for convenience of description. However, in an actual base station, pulse shaping and analog-to-digital conversion may be performed.

The terminal 1220 may use the correlator 1221 whose coefficients are defined as in Equation 38 to detect the PSS sequence transmitted by the base station 1210.

$${h}_{i} [ n ] = {s}_{i} [ n ] + {a}_{i} [ n ] , \qquad [ Equation 38 ]$$

$$n = 0 , 1 , … , N - 1$$

Here, sᵢ[n] may be the i-th PSS sequence in the time domain, and aᵢ[n] may be the i-th auxiliary sequence. The objective of the auxiliary sequence may be to assist sᵢ[n] to improve the characteristics of the output of the correlator 1221, as previously described. In addition, as previously described, the auxiliary sequence aᵢ[n] should be orthogonal to sᵢ[n] to avoid interference, which may be expressed again as in Equation 39.

$${a}_{i} [ n ] ⊥ {s}_{i} [ n ] , \qquad [ Equation 39 ]$$

$$i = 0 , 1 , … , P - 1$$

Orthogonality may ensure that, when sᵢ[n] is detected (that is, j=i and the received sequence sⱼ[n] is perfectly aligned with hᵢ[n]), the output peak of the correlator 1221 is not affected by the addition of the auxiliary sequence. When aᵢ[n]=0, the PSS detector 1221 according to the present disclosure may be reduced to a conventional correlator.

Since hᵢ[n]=0 for n<0 or n≥N, the correlation between sⱼ[n] and hᵢ[n] may be expressed as in Equation 40.

$${r}_{i j} [ n ] = corr ( {s}_{j} [ m + n ] , {h}_{i} [ m ] ) = {\sum }_{m = 0}^{N - 1} {s}_{j} [ m + n ] {h}_{i}^{*} [ m ] \qquad [ Equation 40 ]$$

In Equation 40, the range of the value of n may be −(N−1)≤n≤N−1.

### B. Objective Function

In the present disclosure, the cost function described above may have the same meaning as the objective function described below. Therefore, the cost function described above may be replaced with the objective function described below, or the objective function described below may be replaced with the cost function described above. Hereinafter, the term objective function will be used for description.

The objective function may be defined as shown in Equation 41.

$$f = {w}_{a} {\sum }_{i = 0}^{P - 1} {\sum }_{\begin{matrix}n = - ( N - 1 ) \\ n \neq - r , … , r\end{matrix}}^{N - 1} {\vert {r}_{i i} [ n ] \vert}^{2 q} + {w}_{c} {\sum }_{i = 0}^{P - 1} {\sum }_{\begin{matrix}j = 0 \\ j \neq i\end{matrix}}^{P - 1} {\sum }_{n = - ( N - 1 )}^{N - 1} {\vert {r}_{i j} [ n ] \vert}^{2 q} \qquad [ Equation 41 ]$$

In Equation 41, q may be greater than or equal to 1 (q≥1). The first term in Equation 41 may represent a cost due to sidelobes of the autocorrelation, and the second term may represent a cost related to cross-correlation among different sequences. Also, in Equation 41, the parameter wₐ may be a weight related to the autocorrelation term, and the parameter w_{c} may be a weight related to the cross-correlation term. For convenience of description, the present disclosure assumes wₐ=w_{c}=1. By minimizing ƒ in Equation 41, an auxiliary sequence may be found that exhibits a low sidelobe level in autocorrelation and minimum cross-correlation among different sequences.

In the first term of Equation 41, a summation over n (from −N+1 to N−1) may exclude values within a range defined by an exclusion radius r (that is, n≠−r, . . . , r). This exclusion may indicate that the autocorrelation value at n=0 and its vicinity is ignored. Further description regarding the exclusion radius is provided below.

Next, when q=1, the ‘cost’ may represent a power term. On the other hand, when q>1, although the cost may not be physically interpreted clearly, greater penalties may be applied to noticeable spikes in both the sidelobe and the cross-correlation.

To find the optimal auxiliary sequence that minimizes the objective function ƒ in Equation 41, it may be more convenient to convert Equation 41 into a matrix form. When converting Equation 41 into a matrix form, the correlation defined in Equation 40 may be expressed as shown in Equation 42.

$${r}_{j i} [ n ] = {h}_{i}^{H} {D}_{n} {s}_{j} , \qquad [ Equation 42 ]$$

$$- ( N - 1 ) \leq n \leq N - 1$$

In Equation 42, hᵢ may be a sum of a specific PSS sequence s; and an auxiliary sequence aᵢ, and aᵢ and sⱼ may respectively be the N×1 vector representations of aᵢ[n] and sⱼ[n]. In addition, Dₙ in Equation 42 may be an N×N shifted identity matrix (or n-th superdiagonal matrix), in which the element at the i-th row and j-th column is defined as in Equation 43.

$${( {D}_{n} )}_{i , j} = {δ}_{j , i + n} \qquad [ Equation 43 ]$$

In Equation 43, δ_{j,i+n} may be a Kronecker delta. D₋ₙ may be Dₙ^{T}. Substituting Equation 42 into Equation 41 yields Equation 44.

$$f = {w}_{a} {\sum }_{i = 0}^{P - 1} {\sum }_{\begin{matrix}n = - ( N - 1 ) \\ n \neq - r , … , r\end{matrix}}^{N - 1} {( {h}_{i}^{H} {Q}_{i} [ n ] {h}_{i} )}^{q} + {w}_{c} {\sum }_{i = 0}^{P - 1} {\sum }_{\begin{matrix}j = 0 \\ j \neq i\end{matrix}}^{P - 1} {\sum }_{n = - ( N - 1 )}^{N - 1} {( {h}_{i}^{H} {Q}_{j} [ n ] {h}_{i} )}^{q} \qquad [ Equation 44 ]$$

In Equation 44, Qᵢ[n] may be defined as shown in Equation 45.

$${Q}_{i} [ n ] = {D}_{n} {s}_{i} {s}_{i}^{H} {D}_{n}^{H} , - ( N - 1 ) \leq n \leq N - 1 \qquad [ Equation 45 ]$$

The optimization problem considering the orthogonality constraint may be expressed as shown in Equations 46 and 47.

$${arg min}_{{a}_{i} ∈ {ℂ}^{N}} f ( {a}_{0} , … , {a}_{P - 1} ) \qquad [ Equation 46 ]$$

$$subject to {a}_{i}^{H} {s}_{i} = 0 , i = 0 , … , P - 1 \qquad [ Equation 47 ]$$

In Equation 46, ƒ(a₀, . . . , a_{P-1}) may be the objective function defined in Equation 44. The objective function may be expressed as a function of the auxiliary sequence vectors a₀, . . . , a_{P-1}. This may be to emphasize that the goal is to optimize these parameters to minimize ƒ.

### C. Convexity of the Objective Function

First, when q is 1, the objective function ƒ(a₀, . . . , a_{P-1}) is strictly convex, and when q is greater than 1 (q>1), the strict convexity of ƒ(a₀, . . . , a_{P-1}) may be maintained.

When q is 1 (q=1), the objective function in Equation 44 may be simplified as shown in Equation 48.

$$f ( {a}_{0} , … , {a}_{P - 1} ) = {\sum }_{i = 0}^{P - 1} {h}_{i}^{H} {R}_{i} {h}_{i} \qquad [ Equation 48 ]$$

In Equation 48, Rᵢ may be defined as shown in Equation 49.

$${R}_{i} = {w}_{a} {{\sum }_{n = - ( N - 1 )}}_{n \neq - r , … r}^{N - 1} {Q}_{i} [ n ] + {w}_{c} {{\sum }_{j = 0}}_{j \neq i}^{P - 1} {\sum }_{n = - ( N - 1 )}^{N - 1} {Q}_{j} [ n ] \qquad [ Equation 49 ]$$

It should be noted that the objective function in Equation 48 is a sum of quadratic functions.

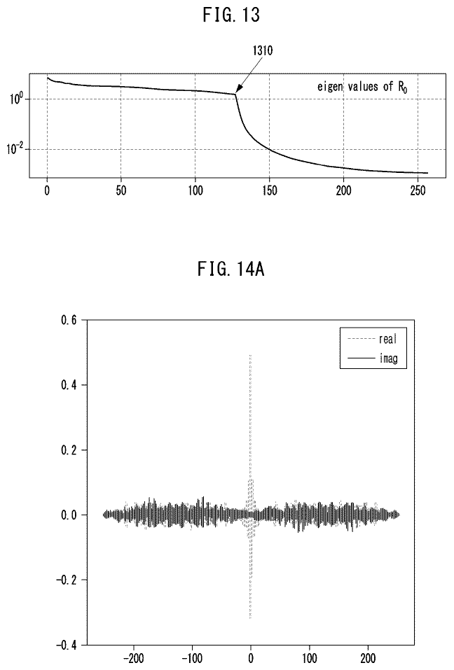

FIG. 13 is a graph illustrating an eigenvalue spectrum of R₀.

FIG. 13 shows a graph of the eigenvalue spectrum of R₀, where the largest and smallest eigenvalues may be 6.81 and 0.001094, respectively. Reference numeral 1310 in FIG. 13 may denote the 127th eigenvalue. The eigenvalue spectrums of R₁ and R₂ may have nearly identical shapes.

As shown in FIG. 13, since all eigenvalues of Rᵢ are positive, the objective function ƒ (a₀, . . . , a_{P-1}) may be strictly convex with respect to each vector aᵢ. In the objective function, i may take values 0 to P−1. In general, the fact that the objective function ƒ(a₀, . . . , a_{P-1}) is strictly convex with respect to each vector aᵢ does not guarantee a joint convexity of the objective function ƒ(a₀, . . . , a_{P-1}) with respect to the vector set {a₀, . . . , a_{P-1}}. However, since the objective function ƒ(a₀, . . . , a_{P-1}) may be expressed as a sum of quadratic functions as in Equation 48, the objective function ƒ(a₀, . . . , a_{P-1}) may be strictly convex with respect to the vector set {a₀, . . . , a_{P-1}}.

Since the objective function ƒ in the special case of q=1 is strictly convex, it is possible to show that the objective function is also strictly convex in the general case of q≥1 using the following proposition.

Proposition 1: Let ƒ be the objective function defined as in Equation 50.

$$f = {\sum }_{n} {g}_{n} \qquad [ Equation 50 ]$$

In Equation 50, each gₙ may be a non-negative convex function for all n. In this case, if the objective function ƒ is strictly convex, then the function defined in Equation 51 is also strictly convex for all real values q≥1.

$${f}_{q} = {\sum }_{i} {g}_{i}^{q} \qquad [ Equation 51 ]$$

The present disclosure does not provide a strict proof of Proposition 1. However, the proof may be easily derived by following the steps below.
1) gₙ is a non-negative convex function for all n.
2) Assume g₁+g₂ is strictly convex, I is a convex set, and λ∈[0, 1] and x, y∈I. Then, Equation 52 is assumed to hold.

$${g}_{1} ( {λ}_{x} + ( 1 - λ ) g ) = λ {g}_{1} ( x ) + ( 1 - λ ) {g}_{1} ( y ) \qquad [ Equation 52 ]$$

Then g₂ is strictly convex on the convex set I.
3) If g(x) is convex and non-negative, then h(x)=g^{q}(x) is convex for q≥1.
4) If g(x) is strictly convex and non-negative on the convex set I, then g^{q}(x) is strictly convex on I for q≥1.

The graph of eigenvalue spectrum in FIG. 13 above requires some explanation. As previously described, each Rᵢ with i=0, . . . , P−1 may exhibit nearly identical eigenvalue spectra. This may be because the P PSS sequences are derived from the same m-sequence via cyclic shifts. Each matrix may have 256 positive eigenvalues, and a ratio between the largest and smallest eigenvalues is approximately 6200, which may be considered favorable for numerical stability in various matrix operations. In particular, each Rᵢ may have prominent eigenvalues corresponding to the length of the PSS sequence in the frequency domain, that is, the number of non-zero subcarriers in the corresponding OFDM symbol (in this case, 127 non-zero subcarriers in the OFDM symbol; see FIG. 11).

This observation naturally raises a question on the reason why the remaining 129 eigenvalues are non-zero. According to Shannon's sampling theorem, if a band-limited signal is sampled at a rate higher than the Nyquist rate, the original signal can be perfectly reconstructed. However, since the time-domain PSS sequence has finite length on the time axis and is not periodic, it may be regarded as having infinite bandwidth. As a result, the time-domain PSS sequence includes frequency components generated due to aliasing during the sampling process, and eigenvalues with indices greater than 128 represent the power of such components.

D. Optimal Auxiliary Sequence: Case of q=1

When q is 1 (q=1), a closed-form solution may exist. To derive a closed-form solution, the Method of Lagrange multipliers may be used. First, a Lagrangian function for the optimization problem with a linear constraint may be defined as shown in Equation 53.

$$ℒ = f ( {a}_{0} , … , {a}_{P - 1} ) + {\sum }_{i = 0}^{P - 1} {λ}_{i} {a}_{i}^{H} {s}_{i} \qquad [ Equation 53 ]$$

In Equation 53, the objective function ƒ(a₀, . . . , a_{P-1}) is defined in Equation 48, and λᵢ for i=0, . . . , P−1 may be the Lagrange multipliers associated with the linear constraint in Equation 47.

The original objective function ƒ(a₀, . . . , a_{P-1}) is strictly convex with respect to each auxiliary sequence aᵢ for i=0, . . . , P−1, and the constraint in Equation 47 is linear. Therefore, the Lagrangian function is also strictly convex.

Substituting Equation 48 and hᵢ=sᵢ+aᵢ (i.e. a sum of the i-th PSS sequence s; and the auxiliary sequence aᵢ, which is the output of the adder 1222) into Equation 53, a gradient vector of [symbol] with respect to aᵢ may be expressed as in Equation 54.

$${∇}_{i} ℒ = \frac{\partial ℒ}{\partial {a}_{i}^{*}} = {R}_{i} ( {s}_{i} + {a}_{i} ) + {λ}_{i} {s}_{i} , i = 0 , … , P - 1 \qquad [ Equation 54 ]$$

In Equation 54, R; is defined in Equation 49. [symbol] may attain a minimum value under the condition in Equation 55.

$${∇}_{i} ℒ = {R}_{i} ( {s}_{i} + {a}_{i} ) + {λ}_{i} {s}_{i} = 0 \qquad [ Equation 55 ]$$

Solving Equation 55 for aᵢ yields the optimal auxiliary sequence in terms of the Lagrange multiplier, as shown in Equation 56.

$${a}_{i} = - {s}_{i} - {λ}_{i} {R}_{i}^{- 1} {s}_{i} \qquad [ Equation 56 ]$$

In Equation 56, Rᵢ⁻¹ exists because Rᵢ is positive definite for all i. Then, since sᵢ^{H}aᵢ=0, by left-multiplying both sides of Equation 56 by sᵢ^{H} and solving for λᵢ, the result may be expressed as shown in Equation 57.

$${λ}_{i} = - \frac{{s}_{i}^{H} {s}_{i}}{{s}_{i}^{H} {R}_{i}^{- 1} {s}_{i}} \qquad [ Equation 57 ]$$

By substituting Equation 57 into Equation 56, the optimal auxiliary sequence may be obtained as shown in Equation 58.

$${a}_{i , opt} = ( \frac{{s}_{i}^{H} {s}_{i}}{{s}_{i}^{H} {R}_{i}^{- 1} {s}_{i}} {R}_{i}^{- 1} - I ) {s}_{i} \qquad [ Equation 58 ]$$

In Equation 58, i may take values from 0 to P−1. The optimal auxiliary sequence obtained through Equation 58 is valid only in the case of q=1.

E. Optimal Auxiliary Sequence: Case of q>1

When q is greater than or equal to 1 (q≥1), a closed-form solution does not exist, and an iterative algorithm needs to be used to minimize the objective function.

The iterative algorithm may be derived using the Method of Lagrange multipliers. However, due to the complexity involved in determining the Lagrange multipliers, significant computation is often required. In contrast, a Projected Gradient Descent (PGD) method often provides a more computationally efficient iterative algorithm, especially when the constraint is simple and the projection is straightforward, such as in the case of a linear constraint as in the present disclosure. Therefore, PGD may be preferred in such cases. Moreover, PGD has been proven to converge to a global minimum for a strictly convex cost function, provided a solution exists.

The PGD-based iterative algorithm may be expressed in the following two steps:
Step 1: computation as in Equation 59 may be performed.
Step 2: computation as in Equation 60 may be performed.

$${z}_{i} [ k + 1 ] := {a}_{i} [ k ] - μ {∇}_{i} f [ k ] \qquad [ Equation 59 ]$$

$${a}_{i} [ k + 1 ] := {z}_{i} [ k + 1 ] - \frac{{s}_{i}^{H} {z}_{i} [ k + 1 ]}{{s}_{i}^{H} {s}_{i}} {s}_{i}$$

In Equation 59, f[k] is the objective function at the k-th iteration, and hᵢ[k] may be a sum of the i-th PSS sequence sᵢ and the auxiliary sequence aᵢ[k]. In addition, ∇ᵢf[k] in Equation 59 may be defined as in Equation 61.

$$[ Equation 61 ]$$

$${∇}_{i} f [ k ] = {w}_{a} {{\sum }_{n = - ( N - 1 )}}_{n \neq - r , … , r}^{N - 1} {q ( {{h}_{i} [ k ]}^{H} {Q}_{i} [ n ] {h}_{i} [ k ] )}^{q - 1} {Q}_{i} [ n ] {h}_{i} [ k ] + {w}_{c} {\sum }_{{j = 0}_{j \neq i}}^{P - 1} {\sum }_{n = - ( N - 1 )}^{N - 1} {q ( {{h}_{i} [ k ]}^{H} {Q}_{j} [ n ] {h}_{i} [ k ] )}^{q - 1} {Q}_{j} [ n ] {h}_{i} \text{?}$$

$$\text{?} \text{indicates text missing or illegible when filed}$$

In the first step, an unconstrained gradient descent update is performed once, which may cause the current sequence to move outside the constraint space. The second step may be a projection procedure that maps the sequence back to the nearest point within the constraint space.

### [Optimized PSS Detection Performance]

### A. Exclusion Radius r

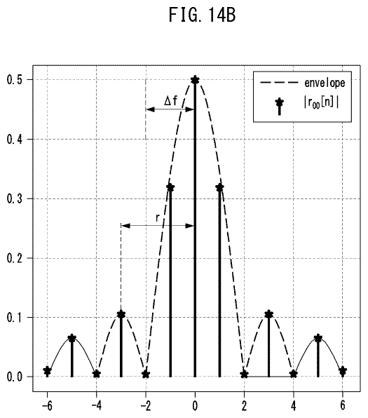

FIG. 14A is a simulation graph of r₀₀[n] of a conventional correlator, and FIG. 14B is a graph illustrating a peak area near n=0 for the same signal in further detail.

A correlator with coefficients hᵢ[n] may be mathematically equivalent to a linear filter with filter coefficients hᵢ*[n]. A linear filter modifies an amplitude and phase of each frequency component of the input signal but cannot generate frequency components that do not exist in the input. Referring to FIG. 14A, the graph of r₀₀[n] for a conventional correlator (i.e. the output of the s₀[n] detector when s₀[n] is received) shows a peak at zero. Since the 0th PSS sequence s₀[n] is band-limited to occupy only 127 subcarriers among 256 subcarriers, the maximum achievable time resolution may be limited by Δf, as shown in FIG. 14B. This may indicate that the auxiliary sequence a₀[n] cannot cancel the sidelobes immediately adjacent to the peak, because it merely represents the coefficients of a linear filter and thus cannot generate nonexistent frequency components.

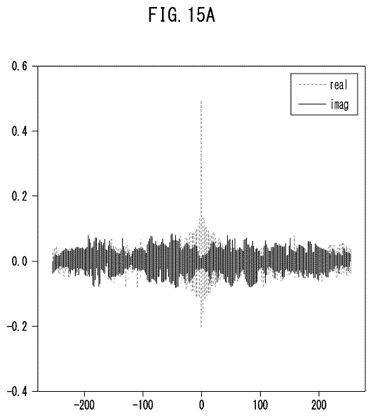

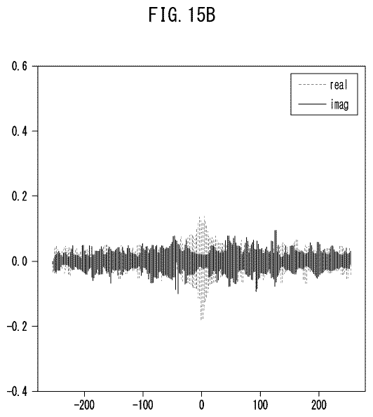

FIG. 15A is a simulation graph of r₀₀[n] for a PSS detector according to the present disclosure with exclusion radius r=0 and q=4, and FIG. 15B is a graph of a correlation function between s₀[n] and the auxiliary signal a₀[n] under the same conditions.

FIGS. 15A and 15B demonstrate side effects that occur when the auxiliary sequence is forced to cancel sidelobes near the peak. Since the input signal s₀[n] lacks sufficiently high-frequency components, a₀[n] needs to modify the amplitude of low-frequency components to cancel signals within the exclusion radius. Accordingly, excessive sidelobes may occur, as seen in FIG. 15A (compared to FIG. 14A).

FIG. 15B illustrates the correlation between s₀[n] and a₀[n] (auxiliary sequence only), showing both the concentrated assistance near n=0 and the unintended side effects.

Experimental evaluations confirm that optimal performance is achieved when r=3, and no further performance improvement is observed when r exceeds 3.

### B. Performance of the PSS Detector According to the Present Disclosure

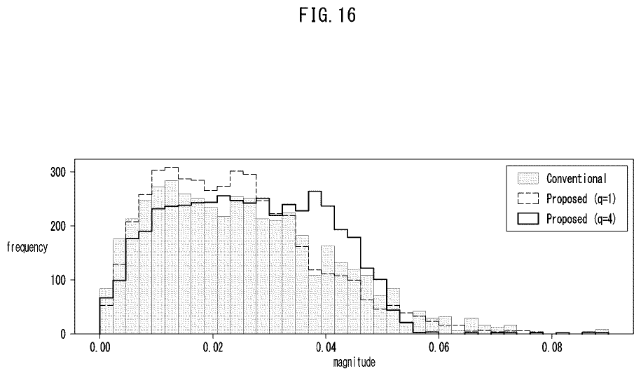

FIG. 16 is a histogram illustrating sidelobe magnitudes of autocorrelation and magnitudes of cross-correlation.

Referring to FIG. 16, distributions of autocorrelation and cross-correlation magnitudes for the current 5G NR PSS detector and the proposed PSS detector are shown. The distributions illustrated in FIG. 16 may represent a case where peaks and sidelobes within the exclusion radius r are excluded. In the distribution of the current 5G NR detector (Conventional), spikes greater than 0.08 in magnitude are observed, and many spikes between 0.06 and 0.08 are also found. These spikes in the distribution of the current 5G NR detector may lead to false detections.

In FIG. 16, the distribution of the PSS detector according to the present disclosure when q=1 may correspond to the case where the exclusion radius is r=3. In the case of q=1, the distribution of the proposed PSS detector shows that spikes greater than 0.08 are almost eliminated, and the number of spikes with magnitudes between 0.06 and 0.08 is significantly smaller compared to that of the current 5G NR detector. Furthermore, the distribution of the proposed PSS detector when q=1 also shows that an average power of the sidelobes in the autocorrelation and an average power in the cross-correlation are both reduced compared to the conventional detector.

In FIG. 16, the distribution of the PSS detector according to the present disclosure when q=4 may also correspond to the case where the exclusion radius is r=3. In this case, spikes with magnitudes greater than 0.06 are almost completely removed. However, an average power of the sidelobes and cross-correlation is significantly higher than that of the proposed PSS detector when q=1.

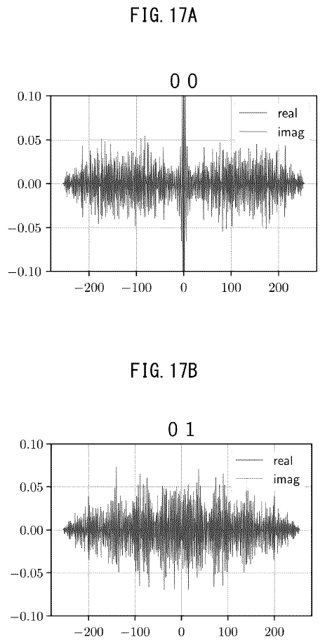

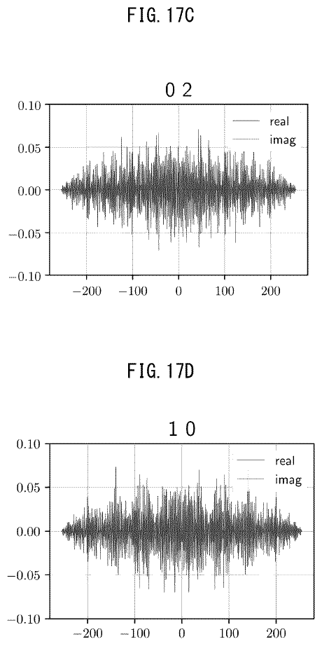

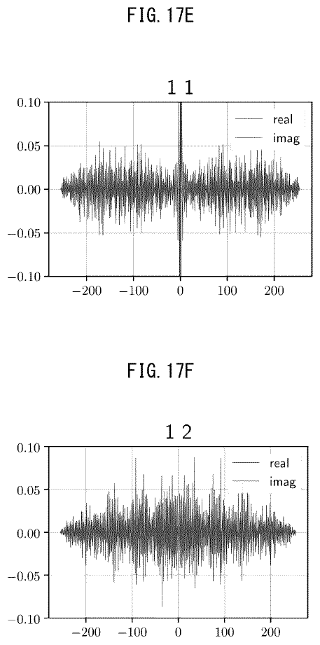

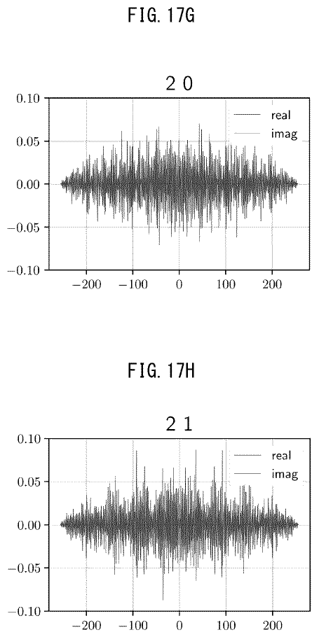

FIGS. 17A to 17I are graphs illustrating outputs of a correlator for PSS sequences in a 5G NR terminal.

First, FIGS. 17A to 17I as illustrated in the present disclosure are color diagrams. The graphs shown in FIGS. 17A to 17I may represent the outputs of the correlator when sequences are received from the base station and the correlator of a terminal does not use the auxiliary sequence proposed in the present disclosure. Each graph in FIGS. 17A to 17I may be showing one of nine plots of all possible combinations between the received PSS sequence sᵢ[n] and the correlator coefficients hᵢ[n] of the terminal. Since the 5G NR system uses three PSS sequences, j=0, 1, 2 and i=0, 1, 2.

More specifically, FIG. 17A is a graph of an aperiodic correlation (autocorrelation) function between the zeroth PSS and the zeroth PSS among 5G NR PSS sequences in a correlator of a 5G NR terminal, FIG. 17B is a graph of an aperiodic correlation (cross-correlation) function between the zeroth PSS and the first PSS among 5G NR PSS sequences in a correlator of a 5G NR terminal, FIG. 17C is a graph of an aperiodic correlation (cross-correlation) function between the zeroth PSS and the second PSS among 5G NR PSS sequences in a correlator of a 5G NR terminal, FIG. 17D is a graph of an aperiodic correlation (cross-correlation) function between the first PSS and the zeroth PSS among 5G NR PSS sequences in a correlator of a 5G NR terminal, FIG. 17E is a graph of an aperiodic correlation (cross-correlation) function between the first PSS and the first PSS among 5G NR PSS sequences in a correlator of a 5G NR terminal, FIG. 17F is a graph of an aperiodic correlation (cross-correlation) function between the first PSS and the second PSS among 5G NR PSS sequences in a correlator of a 5G NR terminal, FIG. 17G is a graph of an aperiodic correlation (cross-correlation) function between the second PSS and the zeroth PSS among 5G NR PSS sequences in a correlator of a 5G NR terminal, FIG. 17H is a graph of an aperiodic correlation (cross-correlation) function between the second PSS and the first PSS among 5G NR PSS sequences in a correlator of a 5G NR terminal, and FIG. 17I is a graph of an aperiodic correlation (cross-correlation) function between the first PSS and the second PSS among 5G NR PSS sequences in a correlator of a 5G NR terminal.

Accordingly, the plots in FIGS. 17A, 17E, and 17I may correspond to autocorrelation function graphs, while the remaining plots may correspond to cross-correlation function graphs. Furthermore, the plots in FIGS. 17A to 17I utilize vertically expanded scaling to emphasize the detailed structure of the sidelobes and spikes located on both sides of the main peak. For example, it can be observed that the vertical axis scale of FIG. 17A differs from that of FIG. 14A discussed earlier. Based on the plots in FIGS. 17A to 17I, it can be seen that random spikes are observed throughout the graphs, particularly in the cross-correlation plots.

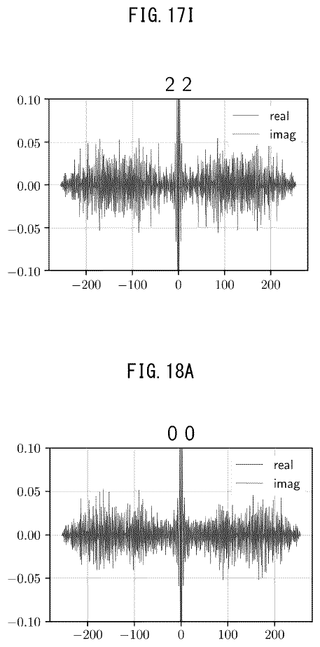

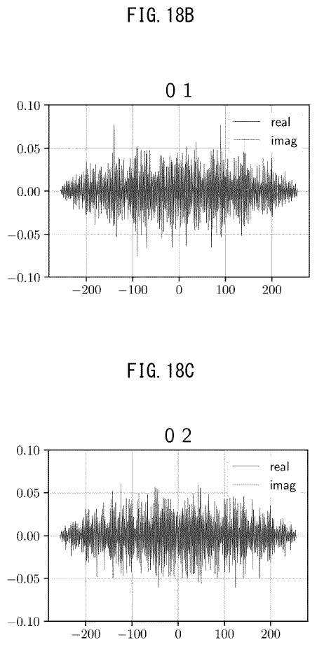

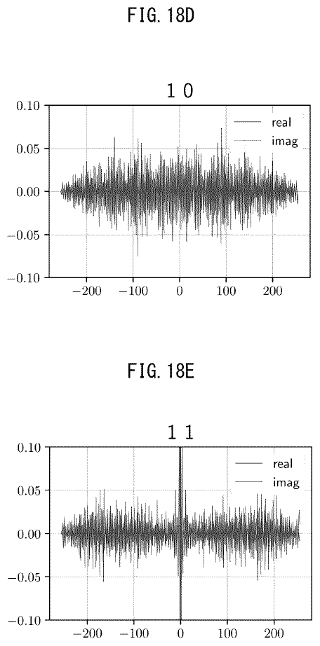

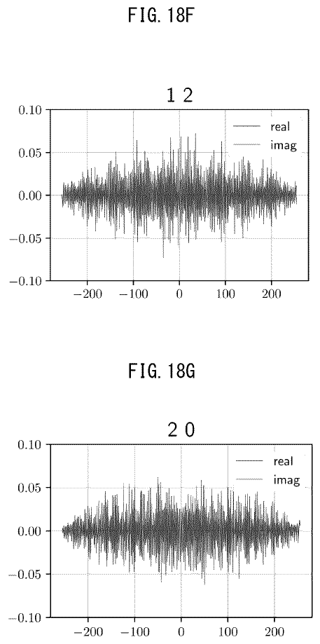

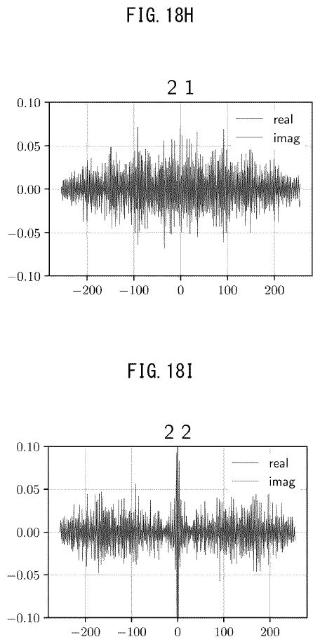

FIGS. 18A to 18I are graphs of the aperiodic correlation (autocorrelation) functions of optimized PSS sequences when the auxiliary sequence according to the present disclosure is used in a terminal and q=1 and r=3.

First, FIGS. 18A to 18I illustrated in the present disclosure are color diagrams. Each of the graphs shown in FIGS. 18A to 18I may represent one of nine plots showing all possible combinations between a received PSS sequence sⱼ[n] and the correlator coefficients hᵢ[n] when the auxiliary sequence according to the present disclosure is used and q=1 and r=3. As the 5G NR system employs three PSS sequences, j=0, 1, 2 and i=0, 1, 2.

More specifically, FIG. 18A is a graph of an aperiodic correlation (cross-correlation) function between the zeroth PSS and the zeroth PSS among optimized PSS sequences when q=1 and r=3 in a correlator of a terminal using an auxiliary sequence, FIG. 18B is a graph of an aperiodic correlation (cross-correlation) function between the zeroth PSS and the first PSS among optimized PSS sequences when q=1 and r=3 in a correlator of a terminal using an auxiliary sequence, FIG. 18C is a graph of an aperiodic correlation (cross-correlation) function between the zeroth PSS and the second PSS among optimized PSS sequences when q=1 and r=3 in a correlator of a terminal using an auxiliary sequence, FIG. 18D is a graph of an aperiodic correlation (cross-correlation) function between the first PSS and the zeroth PSS among optimized PSS sequences when q=1 and r=3 in a correlator of a terminal using an auxiliary sequence, FIG. 18E is a graph of an aperiodic correlation (cross-correlation) function between the first PSS and the first PSS among optimized PSS sequences when q=1 and r=3 in a correlator of a terminal using an auxiliary sequence, FIG. 18F is a graph of an aperiodic correlation (cross-correlation) function between the first PSS and the second PSS among optimized PSS sequences when q=1 and r=3 in a correlator of a terminal using an auxiliary sequence, FIG. 18G is a graph of an aperiodic correlation (cross-correlation) function between the second PSS and the zeroth PSS among optimized PSS sequences when q=1 and r=3 in a correlator of a terminal using an auxiliary sequence, FIG. 18H is a graph of an aperiodic correlation (cross-correlation) function between the second PSS and the first PSS among optimized PSS sequences when q=1 and r=3 in a correlator of a terminal using an auxiliary sequence, and FIG. 18I is a graph of an aperiodic correlation (cross-correlation) function between the second PSS and the second PSS among optimized PSS sequences when q=1 and r=3 in a correlator of a terminal using an auxiliary sequence.

As previously described, among the plots of FIGS. 18A to 18I, the plots of FIGS. 18A, 18E, and 18I may be graphs of functions for autocorrelation, and the remaining plots may be graphs of functions for cross-correlation. In the plots of FIGS. 18A to 18I, the closed-form solution described above in Equation 58 has been used.

In the plots of FIGS. 18A to 18I, it can be confirmed that the output signal of the correlator has lower power than the output signal of the correlator illustrated in the plots of FIGS. 17A to 17I. This may be because the objective function represents the power of sidelobes and cross-correlation when q=1.

Meanwhile, it can also be confirmed that although random spikes are fewer in the plots of FIGS. 18A to 18I than in the plots of FIGS. 17A to 17I, some spikes still remain. To suppress such spikes more effectively, a value of q greater than 1 (i.e. q>1) should be selected. In order to more effectively suppress the spikes, an optimized auxiliary sequence may be obtained by using the two-step PGD-based iterative algorithm employing Equations 59 and 60 described above.

As confirmed by the experiment, as the value of q increases, the spikes decrease. However, it has been confirmed through experiments that when the value of q exceeds 4, performance improvement does not significantly increase. In the present disclosure, the convergence coefficient μ was determined by a heuristic method as the value obtained by dividing the largest non-divergent μ by 5.

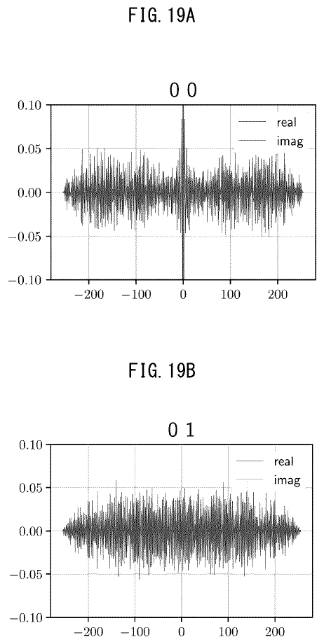

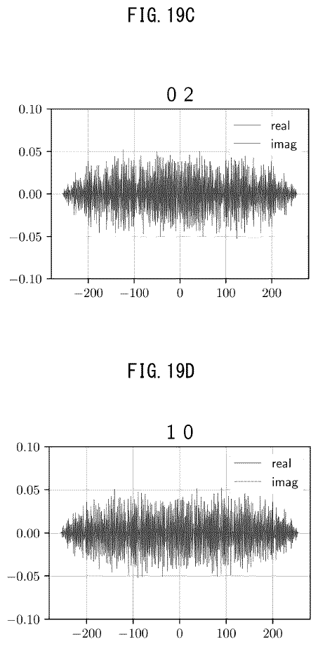

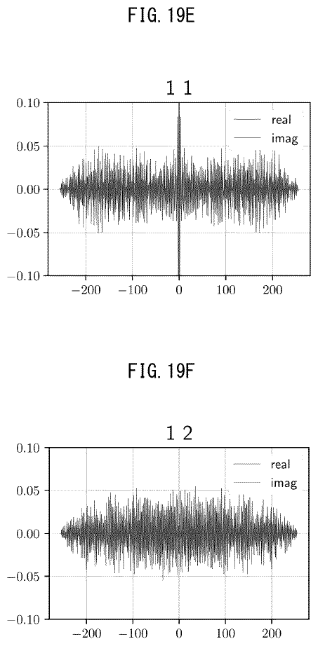

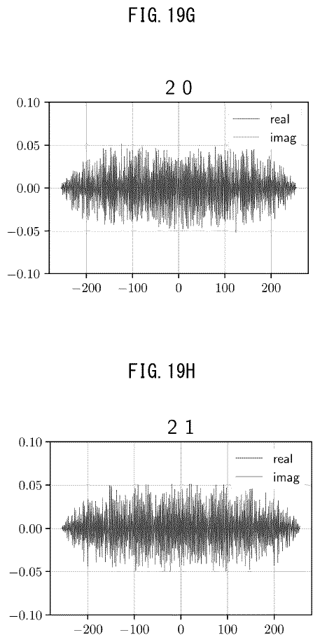

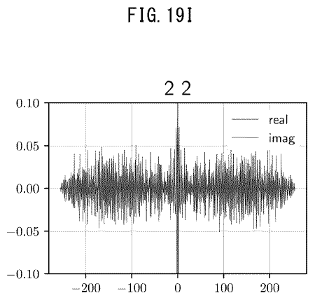

FIGS. 19A to 19I are graphs of aperiodic correlation (autocorrelation) functions of optimized PSS sequences when q=4 and r=3 in a correlator of a terminal using an auxiliary sequence according to the present disclosure.

First, FIGS. 19A to 19I illustrated in the present disclosure are color diagrams. Each of the graphs illustrated in FIGS. 19A to 19I may be one of nine plots showing all possible combinations between a received PSS sequence sⱼ[n] and the correlator coefficients hᵢ[n] when q=4 and r=3 in a correlator of a terminal using the auxiliary sequence according to the present disclosure. Since three PSS sequences are used in 5G NR, j=0, 1, 2 and i=0, 1, 2.

More specifically, FIG. 19A is a graph of an aperiodic correlation (cross-correlation) function between the zeroth PSS and the zeroth PSS among optimized PSS sequences when q=4 and r=3 in a correlator of a terminal using an auxiliary sequence, FIG. 19B is a graph of an aperiodic correlation (cross-correlation) function between the zeroth PSS and the first PSS among optimized PSS sequences when q=4 and r=3 in a correlator of a terminal using an auxiliary sequence, FIG. 19C is a graph of an aperiodic correlation (cross-correlation) function between the zeroth PSS and the second PSS among optimized PSS sequences when q=4 and r=3 in a correlator of a terminal using an auxiliary sequence, FIG. 19D is a graph of an aperiodic correlation (cross-correlation) function between the first PSS and the zeroth PSS among optimized PSS sequences when q=4 and r=3 in a correlator of a terminal using an auxiliary sequence, FIG. 19E is a graph of an aperiodic correlation (cross-correlation) function between the first PSS and the first PSS among optimized PSS sequences when q=4 and r=3 in a correlator of a terminal using an auxiliary sequence, FIG. 19F is a graph of an aperiodic correlation (cross-correlation) function between the first PSS and the second PSS among optimized PSS sequences when q=4 and r=3 in a correlator of a terminal using an auxiliary sequence, FIG. 19G is a graph of an aperiodic correlation (cross-correlation) function between the second PSS and the zeroth PSS among optimized PSS sequences when q=4 and r=3 in a correlator of a terminal using an auxiliary sequence, FIG. 19H is a graph of an aperiodic correlation (cross-correlation) function between the second PSS and the first PSS among optimized PSS sequences when q=4 and r=3 in a correlator of a terminal using an auxiliary sequence, and FIG. 19I is a graph of an aperiodic correlation (cross-correlation) function between the second PSS and the second PSS among optimized PSS sequences when q=4 and r=3 in a correlator of a terminal using an auxiliary sequence.

As previously described, among the plots of FIGS. 19A to 19I, the plots of FIGS. 19A, 19E, and 19I may be graphs of functions for autocorrelation, and the remaining plots may be graphs of functions for cross-correlation. In the plots of FIGS. 19A to 19I, it can be confirmed that the output signal of the correlator is lower in power than the output signal of the correlator illustrated in the plots of FIGS. 17A to 17I. This may be because the objective function represents the power of sidelobes and cross-correlation when q=1.

Meanwhile, in the plots of FIGS. 19A to 19I, it can be confirmed that most of the spikes are removed due to large penalties. However, the average power values illustrated in the plots of FIGS. 19A to 19I are higher than those in the case of FIGS. 18A to 18I.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
calculating first coefficients based on a combination of an i-th primary synchronization signal (PSS) sequence and an auxiliary sequence;
receiving a j-th PSS sequence from a base station; and
determining whether the received j-th PSS sequence corresponds to the i-th PSS sequence based on a correlation between the j-th PSS sequence and the first coefficients,
wherein each of i and j is a natural number indicating an index of one of possible PSS sequences, and the auxiliary sequence is orthogonal to the i-th PSS sequence.

2. The method according to claim 1, wherein the auxiliary sequence is determined based on a sum of a first objective function related to autocorrelation sidelobes of the i-th PSS sequence and a second objective function related to cross-correlation between the i-th PSS sequence and one of sequences other than the i-th PSS sequence.

3. The method according to claim 2, wherein each of the first objective function and the second objective function includes a first element for providing a penalty for cases where a cost increases in the auxiliary sequence.

4. The method according to claim 1, wherein when a value of the first element is greater than 1, each of the first objective function and the second objective function is calculated through iterative operations, and each of the first objective function and the second objective function is iteratively calculated by a projected gradient descent (PGD) scheme during the iterative operations.

5. The method according to claim 4, wherein the iterative operations by the PGD scheme are performed through iterations of first and second steps, the first step is a step of performing a gradient descent update without constraints, and the second step is a step of reprojecting the auxiliary sequence moved out of a constraint space by the gradient descent update to a nearest point within the constraint space.

6. The method according to claim 1, wherein the first objective function is calculated by excluding sidelobes and peaks for autocorrelation within a range of an exclusion radius determined by experiments.

7. A user equipment (UE), comprising at least one processor, wherein the at least one processor causes the UE to perform:
calculating first coefficients based on a combination of an i-th primary synchronization signal (PSS) sequence and an auxiliary sequence;
receiving a j-th PSS sequence from a base station; and
determining whether the received j-th PSS sequence corresponds to the i-th PSS sequence based on a correlation between the j-th PSS sequence and the first coefficients,
wherein each of i and j is a natural number indicating an index of one of possible PSS sequences, and the auxiliary sequence is orthogonal to the i-th PSS sequence.

8. The UE according to claim 7, wherein the auxiliary sequence is determined based on a sum of a first objective function related to autocorrelation sidelobes of the i-th PSS sequence and a second objective function related to cross-correlation between the i-th PSS sequence and one of sequences other than the i-th PSS sequence.

9. The UE according to claim 8, wherein each of the first objective function and the second objective function includes a first element for providing a penalty for cases where a cost increases in the auxiliary sequence.

10. The UE according to claim 9, wherein when a value of the first element is greater than 1, each of the first objective function and the second objective function is calculated through iterative operations, and each of the first objective function and the second objective function is iteratively calculated by a projected gradient descent (PGD) scheme during the iterative operations.

11. The UE according to claim 10, wherein the at least one processor further causes the UE to perform: performing the iterative operations by the PGD scheme through iterations of first and second steps, wherein the first step is a step of performing a gradient descent update without constraints, and the second step is a step of reprojecting the auxiliary sequence moved out of a constraint space by the gradient descent update to a nearest point within the constraint space.

12. The UE according to claim 7, wherein the first objective function is calculated by excluding sidelobes and peaks for autocorrelation within a range of an exclusion radius determined by experiments.

13. A method of designing a primary synchronization signal (PSS), comprising:
collecting requirements of a target system for which the PSS is to be transmitted;
determining a first cost function based on the requirements;
obtaining a first PSS sequence that minimizes the first cost function using a gradient descent algorithm;
testing whether the obtained first PSS sequence satisfies a preconfigured condition; and
in response to the obtained first PSS sequence satisfying the preconfigured condition, determining the obtained first PSS sequence as a final PSS sequence.

14. The method according to claim 13, wherein the requirements include at least one of a first characteristic minimizing a sidelobe level in aperiodic autocorrelation, a second characteristic minimizing an aperiodic cross-correlation level between different sequences, or a third characteristic having a spectral flatness value within a preset spectral flatness value.

15. The method according to claim 14, wherein the cost function is determined based on a combination of a first function for aperiodic autocorrelation and a second function for periodic autocorrelation based on a set of complex frequency domain sequences converted to a time domain based on the first characteristic and the second characteristic.

16. The method according to claim 15, wherein the third characteristic corresponds to a case where a modulus-1 constraint is applied to restrict absolute values of all elements of a sequence to 1 in frequency domain.

17. The method according to claim 15, further comprising: updating the gradient descent algorithm based on the third characteristic.

18. The method according to claim 17, wherein the updating of the gradient descent algorithm comprises:
generating a first intermediate sequence that deviates from the modulus-1 constraint, based on the obtained first PSS sequence; and
generating a second intermediate sequence by normalizing the first intermediate sequence to restore the modulus-1 constraint.

19. The method according to claim 13, further comprising:
in response to the obtained first PSS sequence not satisfying the preconfigured condition, determining whether to redefine the first cost function;
in response to determining to redefine the first cost function, defining a second cost function based on the requirements; and
obtaining a second PSS sequence that minimizes the second cost function using a gradient descent algorithm.

20. The method according to claim 13, further comprising:
in response to the obtained first PSS sequence not satisfying the preconfigured condition, determining whether to redefine the first cost function; and
in response to determining not to redefine the first cost function, obtaining a second PSS sequence that minimizes the first cost function.
